(19) United States
(12) Patent Application Publication
(10) Pub. No.: US 2005/0209959 A1
(43) Pub. Date: Sep. 22, 2005

(54) Financial regime-switching vector auto-regression

(76) Inventor: Mark Stanley Tenney, Alexandria, VA (US)

Correspondence Address: Mr. Mark S. Tenney, 4313 Lawrence Street, Alexandria, VA, 22309, US

(21) Appl. No.: 10/805,314

(22) Filed: Mar. 22, 2004

(51) Int. Cl. G06F 17/60

(52) U.S. Cl. 705/39

(57) ABSTRACT

A regime switching vector autoregression (RS-VAR) is defined as a vector autoregression in which the parameters of the vector autoregression are functions of a set of discrete indices, which consitute the regimes. This process can be applied to interest rate models, default models, and other financial models. This can be done in the “objective” or P-measure or the risk-neutral or Q-measure of finance or other measures. One set of applications include calculation of prices, cashflows, capital, reserves, defaults, and other variables. Another set includes transactions using these including purchases and sales, producing and/or sending reports, advisory services, portfolio strategy, etc.

### CHAPTER 1

### BACKGROUND OF THE INVENTION

1.1 Field of the Invention

Methods, machines and articles of manufacture for simulating financial variables, calculating quantities, preparing to and/or executing transactions. US Classification 705-35 and/or related categories.

1.2 Description of the Related Art

Note that typing in the names of the authors or articles below in a search engine will in many cases allow access to the articles cited herein or related ones or ones by others. JSTOR allows access to many of the historical papers. Individual subscriptions are available to many of the journals with access to JSTOR for that journal. Typing in several authors names together will pick up at least one site that maintains a bibliography of finance papers in these areas. The Society of Actuaries Library, American Academy of Actuaries, Canadian Institute of Actuaries and Faculty and Institute of Actuaries contain works of the author and Mathematical Finance Company and many of these are available on-line at their websites. See the bibliography of term structure literature and derivative pricing by Don Chance [31] and the references in Duffie [45] and Duffie and Singleton [48].

2-1 Pure Regime Switching

See Bharucha-Reid's [21] Chapter 2 for a discussion of discrete space processes in continuous time, and Chapter 1 for processes discrete in time and space. See also Shiryaev [110] for regime switching in discrete time, i.e. Markov chains. The pure regime switching continuous time process implies a pure regime switching discrete time process, even with unequal time intervals. Moreover, matrix methods can be used to compute this matrix. See the references on matrix methods and other references cited elsewhere. See page 64 of Bharucha-Reid [21]. For a finite time interval in which the generator matrix is A, the transition matrix is given by

$$P ( t ) = {\sum }_{i = 0}^{∞} {A}^{n} {t}^{n} / n ! \qquad ( 1.1 )$$

This can be evaluated using the matrix methods discussed in the references. See particularly Patel, Laub and Doren [106].

2-2 Regime Switching in Finance

See Hamilton [60] [61] and [62] for use of regime switching in economics and finance. See Hamilton and Raj [63] for recent applications. Krolzig. See Ang and Bekaert [5]. Babbs and Nowman [8] and Babbs and Webber [9]. See also in the sections below. See [3] and [2] for approximation methods as well for models and processes.

2-3 VAR

The continuous VAR in finance was used by Lantegieg in his paper [87]. This process can be defined as follows.

Definition 1.1 (Continuous-time VAR) There is a vector of state variables, v, that follows the process
dv=(b+Av)dt+Gdw (1.2)
where v is an n by 1 vector of variables, b is an n by 1 vector of parameters, A is n by n, G is n by k and dw is k by 1. The vector dw is a vector of Wiener processes, with mean 0 and variance dt.

This is a slightly more general form than Langetieg.

In Langetieg's model, the instantaneous short term rate is defined by
r=α+β′v (1.3)
Where β is an n by 1 vector of parameters and the prime indicates the transpose. In this notation

$${β}^{′} v = {\sum }_{i = 0}^{n - 1} β [ i ] v [ i ] \qquad ( 1.4 )$$

Note we could also index from i=1 to n instead.

Definition 1.2 (Discrete Time VAR) The n by 1 vector y follows the process
y[t]−y[t−1]=(μ₀[t]+K[t]y[t−1])Δt+Σ[t]\sqrt{Δt} (1.5)
The time interval can vary with time t. It is possible to allow μ,K, Σ to pend on t or be independent of t.

A discrete time VAR need not have an equal time step. In both a continuous and discrete time VAR, the parameter vectors and matrices can be indexed by time. Note that a continuous time VAR determines many discrete time VAR's, corresponding to different sets of time intervals. The matrices in the discrete time VAR and the probability density function, characteristic functions, Green's functions, can be obtained using the methods in the references.

Definition 1.3 (VAR) A vector autoregression, VAR, is either a discrete time VAR or a continuous time VAR.

2-4 Quadratic

The quadratic VAR is the same as Langetieg's model except that r is a quadratic function of the state vector.
r=α+β′v+v′Qv (1.6)
Here Q is n by n. The expression v′Qv is a quadratic form:

$${v}^{′} Q v = {\sum }_{ij} v [ i ] v [ j ] Q [ i ] [ j ] \qquad ( 1.7 )$$

where the sums are from 0 to n-1 or 1 to n depending on the indexing. We normally use 0 to n-1.

See Longstaff [90], Beaglehole and Tenney [19] [20], Constantinides [35], Eterovic [51], Mansitre [94] Ahn, Dittmar, and Gallant [1] Leippold and Wu [89], Andrew Ang and Monika Piazzesi [107] [6] (and the other papers found by searching on their names) and the references in the papers cited herein such as given in Dai and Singleton [42], [41], as well as the many found by searching on “quadratic term structure model” and “quadratic interest rate model”.

2-5 Affine and Regime Switching and Other Models

Dai and Singleton [42], [41] review interest rate models including the affine models as well as regime switching models of the affine and quadratic type. See the text by Duffie [45]. For credit models see Duffie and Singleton [48] as well as the Dai and Singleton references. See also the references cited therein, and also for the affine model Merton [96], Vasicek [125], Cox, Ingersoll and Ross [36], [37], [38], Hull and White [74], Turnbull and Milne [124], Jamshidian [77], [79], [80], [78] [83], [81] Longstaff [90], Langeteig [87], Beaglehole and Tenney [19], [34], Longstaff and Schwartz [92], Eterovic [51], Das [43] Lin Chen [32], Balduzzi, Das, Foresi, and Sundaram [11] [12], [33], [46], Duffie, Pan, and Singleton [47], Pan [104], and the references cited therein. See Shiryaev [111]

See Zhou [127], [15], Bansal and Zhou [14], Bansal, Tauchen and Zhou [13], and Bollerslev and Zhou [24]. See the work of Heath, Jarrow and Morton [70], [72] and models built on their approach. See Fitton [52] and Chacko and Das [30] for solution methods.

2-6 Actuarial Work

American Academy of Actuaries C3 Phase I and C3 Phase II use models for simulatin of assets and liabilities for determining required capital.

See the work of Geoff Hancock of William Mercer and in Canadian Institute of Actuaries, Society of Actuaries and other meetings reporting on C3 Phase II and the Canadian OSFI regulations in this area. See Geoffrey Hancock on bring risk into capital management [64], as well as the other talks in that session, all collected into a pdf file by the SOA. See [103], [102] and at SOA [116], [88].

See also the reports of C3 Phase II of the American Academy of Actuaries [114], [113], and [115]. See also previous reports on Universal Valuation System (UVS) of the American Academy of Actuaries and on Equity Indexed Annuities of the same organization. See the work of Mary Hardy such as [65] for the above organizations and in her book on guarantees in insurance products [66]. A regime switching model for equity volatility and return is reported by Hardy and also by Hancock in the above and has been used by these organizations. The above reports can be found by searching on their titles or authors or on the web pages of those organizations. The above are a selection of the material of these organizations and individuals that will be found from these searches.

See also Casualty Actuary Society papers and work on Dynamic Financial Analysis (DFA), as well as on interest rate models and stochastic simulation. See also papers of other actuarial organizations including the Institute and Faculty of Actuaries, and the International Actuarial Association. Also the ETH insurance, finance and mathematics group, and the actuarial department at the University of Waterloo.

2-7 Matrix Methods

See Langetieg [87], Beaglehole and Tenney [19], Eterovic [51], Lin Chen [32], [33], [16], Duffie, Pan, and Singleton [47], Pan [104] Ahn, Dittmar, and Gallant [1] Leippold and Wu [89], [6] and the other references cited herein as examples of how to use matrix methods to solve for the probability density function over finite time intervals. See also the text by Arnold, Stochastic Differential Equations: Theory and Applications [7]. The book Numerical Linear Algebra Techniques for Systems and Control by Patel, Laub and Doren [106] contains matrix algorithms that can be used as part of this.

2-8 MFC VAR-ESG

The Mathematical Finance Company VAR-Economic Scenario Generator (VAR-ESG) is described briefly here. This product has been used to generate scenarios of yield curves and equity indices. Various papers on this system have appeared over the years at the Society of Actuaries and Canadian Institute of Actuaries. Information is available in the SOA Library and can be searched on the web for either of these. See Tenney [118]. Two presentations at conferences were [119] and [120]. See the important notes in these on the relation of this work to the work of Marjorie and Michael Hogan in the 1980's which was never described in any publication. The first was considered too difficult to print by the SOA and the second was distributed to the participants, but not otherwise published. That book Duffie and Tavella [49] has been cited in U.S. Pat. No. 6,173,276 by an unrelated party. Duffie and Tavella were the conference co-chairs. See the references cited therein including the work of Marjorie and Micheal Hogan [73]. See Groover and Tenney [55], [57], [56] Craighead and Tenney [40] The papers by Craighead and Tenney [40] and by Bobo, Tenney, and Tenney [23] are examples of application or parameter estimation or development. See also papers by Tenney, Craighead in the SOA Library and publications, Actuarial Research Conference and ARCH, Canadian Institute of Actuaries, and references to them in these and other actuarial organizations such as the Casualty Actuarial Society. The latter also has extensive materials on Dynamic Financial Analysis (DFA). The SOA tends to call that Dynamic Financial Conditions Analysis (DFCA).

The system in its normal mode uses the Double Mean Reverting Process™ (DMRP), defined as a 2 variable VAR where the interest rate is an exponential function of the first state variable.
du=k(θ−u)dt+σdz₁ (1.8)
dθ=k₂(θ₂−u)dt+σ₂dz₂ (1.9)
with the correlation of dz₁ and dz₂ being ρ. There are different parameters in the risk neutral and objective measures, i.e. the Q and P measures. Here the short rate is r=e^{u}. Note one can introduce a time-dependent factor, so that r=e^{u}α(t).

Matrix methods referenced above are used to compute the matrices and vectors over discrete time intervals for calculating probability density functions and generating random variables.

Individual yields can be modeled through solving the DMRP. One can also have processes on “yield residuals” such as an AR(1) process. These can be fit to the initial yield curve and decay according to such a process, or a straight line decay over a finite time interval.

2-9 QRMC

Quasi-Random Monte Carlo also sometimes called Low Disrepancy Sequences have been used with the MFC ESG based on a VAR already. This is with a system by Columbia University called FinDer™ based on the Columbia University patents on QRMC/LDS. See U.S. Pat. No. 5,940,810 Traub, Paskov, and Vanderhoof, and U.S. Pat. No. 6,058,377 Traub, Paskov, Vanderhoof, and Papageorgiou.

QRMC/LDS sequences can be used to generate random numbers for both the regime switching and the VAR generation. These can be combined or separate. That is, one can form the variables to be used into one set of variables and apply the QRMC/LDS algorithms to that or apply it to separate sets, e.g. the pure regime switching and the VAR. See the material on Columbia Universities website as well as other references such as those of the University of Waterloo. See the references in the paper by Tenney [121] on QRMC/LDS including web references. This was posted on the Canadian Institute of Actuaries (CIA) website sometime in 2003 and can be found by searching on the title or the author and several other names or within the organization's site.

1.3 Financial Transactions

Financial transactions include the purchase or sale of financial contracts or the election of an option under such a contract or a financial option of a non-financial contract. They also include determining a quantity such as a dividend based on other financial transactions or a report on financial condition.

1.4 Basel

The Bank for International Settlements (BIS) also often called Basel or the Basel Committee is an international body in the area of banking, capital management, risk, regulation and reporting. Its publications including its web site contains extensive documentation on these issues.

Among these see
1. Overview of the New Basel Capital Accord April 2003
2. The Third Consultative Paper of the New Basel Capital Accord, (E), April 2003
3. Basel Committee Publications in a numbered series from 1 to 106 as of January 2004.
4. Basel Committee Working Papers.
5. World Bank Basel related publications.
6. US Federal Reserve Basel related publications.
   1.5 OSFI

Canada's OSFI has taken a lead in regulating financial service capital using simulation.

See the memorandum headed as follows:
Our number: P2218-1 Dec. 23, 1999 TO: Chief Executive Officers Federally Regulated Life Insurance Companies and Fraternal Benefit Societies Subject: Minimum Continuing Capital and Surplus Requirements (MCCSR).

See documents of the Canadian Insitute of Actuaries (CIA) on this subject.

1.6 International Accounting Standards (IAS)

See the work of the International Accounting Standards Board (IASB) especially as it relates to insurance and fair value.

1.7 Financial Accounting Standards Board (FASB)

Work on similar topics to the IAS is available from the FASB.

1.8 Fair Value of Financial Contracts

Fair value of financial contracts is a subject that took on a new dimension with the developments in modern accounting and finance. Of particular importance is the paper by Black Scholes [22], Garman [53], Richard [108], Harrison and Kreps [67], and Harrison and Pliska [68], [69]. This also applies as well to papers tracing back to the portfolio methods of Hakansson's thesis [58]. These include applications to equilibrium pricing by Merton [98], [97], Lucas [93], Vasicek [125], Cox, Ingesoll and Ross [37], [38] and others.

1.9 US House

See hearings related information from The U.S. House Financial Services Committee relating to the Basel Accord on Jun. 16, 2003, Jun. 19, 2003 and other days. See also other documents on their web site found by searching restricted to the restriction of the .gov domain to the Senate.

1.10 US Senate

See hearings related information from The U.S. Senate Committee on Banking, Housing, and Urban Affairs “A Review of the New Basel Capital Accord” Jun. 18, 2003. See also other documents on their web site found by searching restricted to the restriction of the .gov domain to the Senate.

1.11 Additional Review

11-1 Monte Carlo in Finance

Monte Carlo was introduced into finance for the valuation of securities by Boyle in 1977 [27]. Since then it has been widely used for both valuation and risk analysis.

11-2 Option Pricing

Option pricing formulas were developed by Bachelier [10], Kruizenga [86], Sprenkle [112] and Boness [25]¹. Black-Scholes [22] showed how to derive a formula of the same form as Boness [25] using an equilibrium approach.
¹Some notes in the next few subsections are based on those in Davlin et al. Tenney [44] An earlier version of this paper was posted on the SOA website.

Boness and the others had been unable to come up with the right discount rate and expected rate of return, the risk free rate in both cases, these were discovered and proven by Black-Scholes. Black-Scholes report a no-arbitrage derivation based on a suggestion by Merton who showed the Boness type formula with the Black-Scholes parameter restrictions for equity options also obtains if interest rates are normally distributed. Black-Scholes showed how to derive a partial differential equation of the McKean-Samuelson type [95] [109]. Merton [98] extended that equation to include a second random source from interest rates for pricing equity options only. Cox-Ross [39] showed how to interpret the Black-Scholes solution in terms of risk neutral probability and to price options with other stock price processes. This was an economic interpretation of the mathematics of Black-Scholes and Merton which was already risk neutral probability.

The general approach to arbitrage in a single currency was done by Garman [53] at the same time as Richard developed it for just random interest rates [108].² The Garman approach was for any type of security contingent on any type of random variable.
²This was in a 1976 Carnegie Mellon working paper.

11-3 Interest Rate Models

Monte Carlo is the leading method used to price mortgages and equilibrium mortgage interest rates are determined by the use of Monte Carlo simulation models. The mortgage applications use interest rate models as the main random factor. One factor interest rate models under equilibrium were developed by Vasicek [125] and Cox, Ingersoll and Ross [38]³. Richard [108] and Cox, Ingersoll and Ross [38] extended the one factor CIR model to two factors independently.
³Both were working papers in 1976

The key base of modern multi-factor interest rate models with closed form solutions are the multivariate normal models of Langetieg [87] and the two factor square root model of Richard [108] and Cox, Ingersoll and Ross (CIR) [38].

Special cases of Langetieg's model are Ho-Lee, [72], Jamshidian, [77] [79] [80], and Hull and White and [714].

Later models built on Langetieg include the quadratic model Longstaff [90], Beaglehole et al., [19] [20], Jamshidian [81]⁴ Eterovic [51], Ahn, Dittmar, and Gallant [1], Leippold and Wu [89] and others, Lin Chen's [32] 3 factor model and the affine model of Duffie and Kan [46], and the Heath, Jarrow, and Morton (HJM) methodology [70].
⁴See Manistre [94] for a general discussion of multifactor models.

Langetieg derived a Boness-like formula for options on stocks with his interest rate model applying Merton's argument on Black-Scholes. Hull and White showed that Langetieg's approach could be slightly modified to apply to their version of the Langetieg model. State prices or option prices for these models were developed by Cox, Ingersoll and Ross [38] Jamshidian [79], Longstaff [91], Hull and White [74], Beaglehole et al. [10], Milne and Turnbull [124], Chen and Scott [34], Longstaff and Schwartz [92], Constantinides [35], Lin Chen [32], Manistre [94], Duffie, Pan and Singleton [47] and others. Earlier work on state prices or Green's functions in finance traces back to McKean [95], Garman [53], Cox, Ingersoll and Ross [37], Breeden and Litzenberger [29], Banz and Miller [16], Ingersoll [75], and Merton [99].

In addition, Lucas [93] derived state prices building on the foundation of Hakansson's [58], [59] approach to optimal savings, consumption and portfolio choice. Lucas developed a state price using marginal rates of substitution that arise in the Hakansson type optimizations of consumption, savings and portfolio decisions in a multiple-period context. Cox, Ingersoll and Ross and Vasicek's equilibriums are also built on the Hakansson foundation.

Because of the prepayment models and the frequent use of interest rate models without closed form solution, Monte Carlo and Low Discrepancy Sequences are often used for mortgage pricing and risk analysis. An example of a model without a closed form is the DMRP™⁵ model, see for example Groover [55], Groover et al. [57] and Craighead et al. [40].
⁵Trademark Mark Tenney and Mathematical Finance Company.

11-4 Insurance Applications

Monte Carlo has been applied to insurance products or asset liability management by Boyle, Brender, Brown, Craighead, Embrechts, Fitton, Hancock, Hardy, Manistre, and Panjer in numerous papers and actuarial studies to name but a few. It has been used to set Segregated Fund Guarantee regulations in Canada. It has been used for interpreting CARVM for Equity Indexed Annuities, for C-3 Phase One risk based capital for interest rates, C-3 Phase Two for variable annuity guarantees, and other studied by the American Academy of Actuaries and Canadian Institute of Actuaries.

Monte Carlo has been applied to guarantees on segregated funds by Mary Hardy using a regime switching approach [65]. Error bounds for this model or related ones can be calculated with discrepancy. Low Discrepancy Methods or Quasi-Random Monte Carlo can be combined with that model for analyzing insurance problems such as variable annuity guarantees including reserve and capital requirements.

11-5 Monte Carlo

Monte Carlo was developed at Los Alamos in the 1940's for calculations related to nuclear physics. It has since been applied to a variety of problems from analyzing scattering experiments in accelerators to financial applications.

11-6 Quasi-Random Monte Carlo

Quasi-Random Monte Carlo means deterministic sequences or points. They are usually chosen because they have a lower discrepancy than “randomly” chosen points. Paskov and Papageorgiou [105] review the history of applying Quasi-Random Monte Carlo (QRMC) to high-dimensional problems in finance. The text by Niederreiter [101] is one of the classic texts on QRMC and is the basis of most of the theorems presented later.

Some recent applications of QRMC have been made by Boyle, Broadie and Glasserman [28] and Boyle and Tan [26].

1.12 Copulas

See in particular Chapter 2 of Nelsen [100] and Chapter 2 of Embrechts, Lindskog and McNeil [50]. The errata for Nelsen's book is at his university's webpage. (search on the title or author). However, the entire documents are important material on copulas. A good introduction to applying copulas to reinsurance is by Gary Venter [126]. This has many good pictures of copulas.

This is available at the casualty actuary website.

1.13 FX Modelling

FX stands for foreign exchange. See Davlin and Tenney [44]. An earlier version was posted on the SOA library website. The following references are taken from that paper.
Krugman [85] The Garman-Kohlhagen model without stochastic interest rates appeared in 1983 [54] and also derived a Boness type formula for options on exchange rates. The arbitrage free framework for pricing pricing with stochastic interest rates and exchange rates appears in Ingersoll [76], Amin and Jarrow [4], Jamshidian [82]. The material of section two was based on some fragmentary notes [117] that appeared in a fragmentary draft paper by Beaglehole et al [17]. Some related work on stochastic exchange rates and stochastic volatility are the notes of a paper on stochastic volatility by Beaglehole et al. [18], Heston [71] and Knoch [84], Melino and Turnbull [122] and [123].
   13-1 MFC-FX

A system was used by MFC where a variable v was constructed as follows.

$$v = γ + α {\sum }_{t} ( Δ {r}_{t} ) Δ t + β w \qquad ( 1.10 )$$

where Δrₜ is the difference in interest rates in two currencies at an observiation point and w is some element from the VAR. These were obtained by exponentiating elements of the VAR in each currency. The v variable is constructed from some reference point in time, or a fixed lag. Let Δf be the change in the log of the exchange rate. It is modelled that
Δf=a+bv (1.11)
A continuous time version of this is easily constructed.
   dv=φdt+α(Δrₜ)dt+βdw (1.12)
   (in the case that α, β don't vary with time). Depending on the specification of the exchange rate and interest rate differential, an Ito type term may have to be added or subtracted or such a term as occurs in the derivations in the Davlin Tenney paper.
   1.14 Financial Advisory Systems

See U.S. Pat. Nos. 5,918,217, 6,012,044, 6,021,397, 6,125,355 and 6,292,787;

1.15 Other Financial Systems

See U.S. Pat. No. 5,193,056 on a “Data Processing System for Hub and Spoke Financial Services Configuration.”

### CHAPTER 2

### BRIEF DESCRIPTION OF THE DRAWINGS

2.1 RS-VAR Generation

FIG. 1 is a flow diagram of the generation of the Regime Switching Vector Auto-Regression (VAR).

2.2 Discretized RS-VAR Generation

FIG. 2 is a flow diagram of the Discretized RS-VAR generator Time Loop.

2.3 Discrete Time Regime Probability Propagation

FIG. 3 is a flow diagram of Discrete Time Regime Probability Propagation.

2.4 Matrix Times Random Vector

FIG. 4 is a flow diagram of a matrix times random vector calculation in the discrete time portion of the VAR vector calculation.

2.5 State Variable Fitting

FIG. 5 is a flow diagram of the State Variable Fitting.

2.6 Discretization

FIG. 6 is a flow diagram of calculation of the mean, variance-covariance matrix, the standard deviations and the correlations of the discretized process.

2.7 Yield Grid Generator

FIG. 7 is a flow diagram of the Yield/Price Grid Generation.

2.8 Yield Scenario Generator

FIG. 8 is a flow diagram of the Yield Scenarios Generation.

2.9 Basic ESG

FIG. 9 is a flow diagram of the ESG.

2.10 Auxiliary Scenario Processor

FIG. 10 is a flow diagram of an Auxiliary Scenario Processor. Examples are combining yield grid data and the state variables and also auxiliary data of some sort being tracked.

2.11 Statistical Analyzer Module

FIG. 11 is a flow diagram of the statistical analysis of the scenario data.

2.12 Price

FIG. 12 is a flow diagram of the price calculation using scenarios.

2.13 Sensitivities

FIG. 13 is a flow diagram of the sensitivies calculation. This includes price derivatives with respect to state variables or other paramters such as a spread or option adjusted spread. It includes durations with respect to the state variables and other parameters and a convexity matrix with respect to them and other parameters.

2.14 Reserves

FIG. 14 is a flow diagram of reserves calculation.

2.15 Capital

FIG. 15 is a flow diagram of capital calculation.

2.16 Portfolio Simulator

FIG. 16 is a flow diagram of a portfolio simulator. The portfolio can include assets and liabilities.

2.17 portfolio simulator scenario loop manager

FIG. 17 is a flow diagram of a portfolio simulator scenario loop manager.

2.18 Portfolio Simulator Scenario Time Loop Manager

FIG. 18 is a flow diagram of a portfolio simulator scenario time loop manager.

2.19 Preparation for Transaction End Use

FIG. 19 is a flow diagram of preparation for a Transaction End Use.

2.20 Transaction End Use

FIG. 20 is a flow diagram of execution of a Transaction End Use.

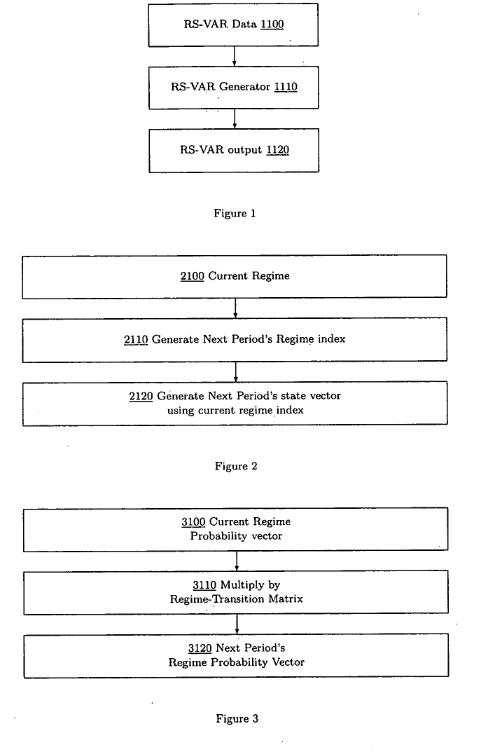

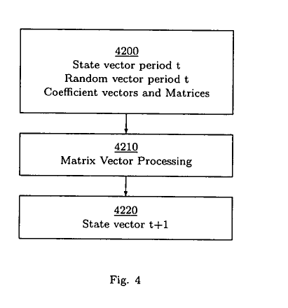

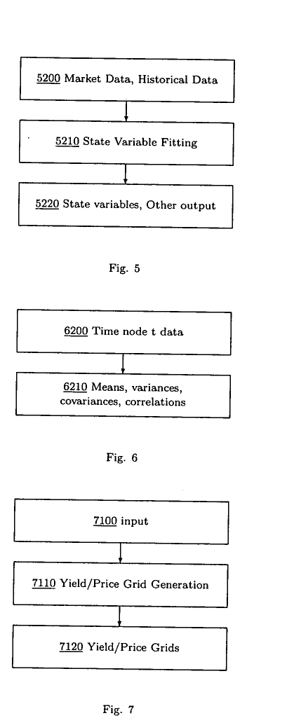

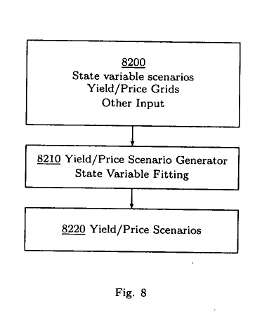

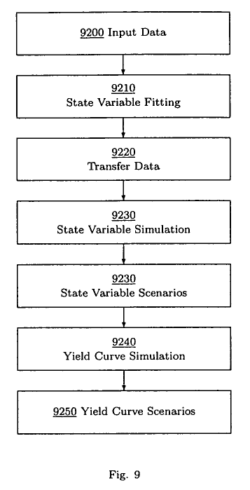

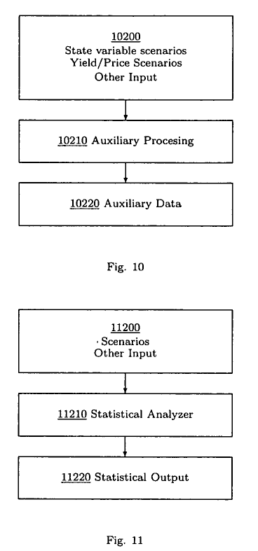

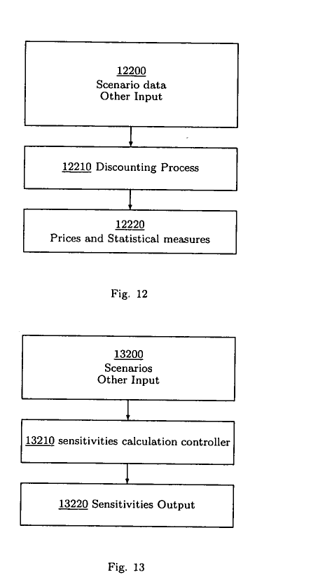

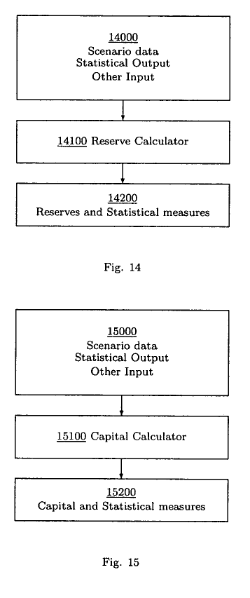

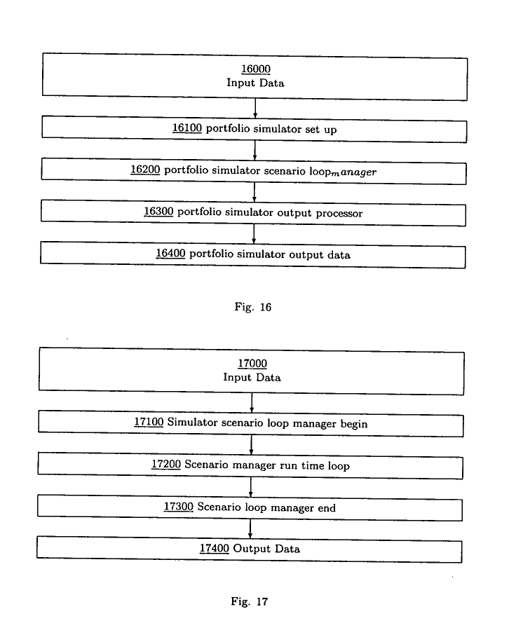

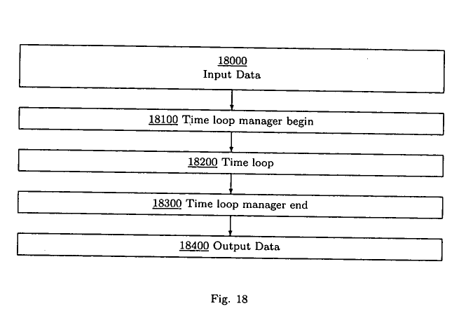

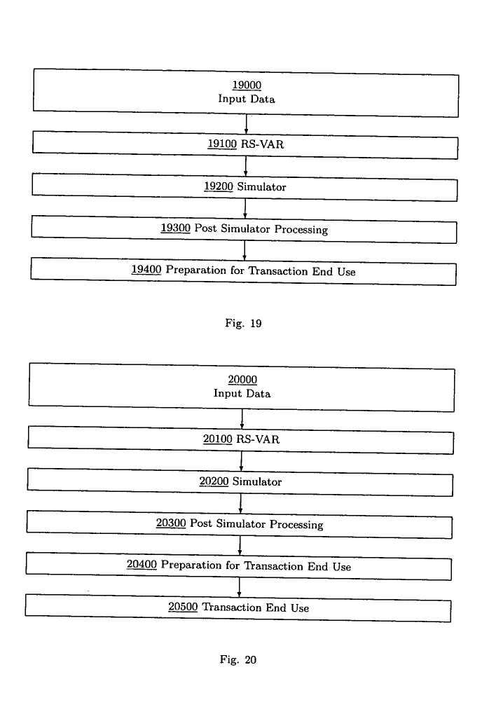

### CHAPTER 3

### SIMULATION

3.1 Introduction

In simulation, we start out by thinking we have the true model of nature or the economy or the economic process and we know everything. We don't have any observation problems, we know the parameters, we know the models, we know how to simulate.

We have as our theoretical model the idea that there are hidden variables which we can model as coming from such joint distribution like the multi-variate normal. We use the latter because it has nice properties especially for modeling many random variables at once.

We have a model though that individual data series that we see in the economy, like the S & P 500 or the price of Ford stock are not normally distributed nor are simple transforms of them like the difference in natural logarithms of them at adjacent time points. Nor is the arithmetic return from one month end to the next month end normally distributed.

So we have a theoretical model that we can simulate with which starts out with the hidden multivariate normal distribution of many variables and simulates those first. Then for each such variable we transform it so as to produce the observable variables such as Ford stock price or the return of Ford stock price which we also classify as an observable because the transformation involves no estimated parameters.

So step one is generate all the normal variables at once for a given time period using a multivariate normal distribution. This models their correlation. Now we take each individual normal and turn it into an observabable. The way we do this is by matching the univariate normal distribution's cumulative distribution to the univariate cumulative distribution of some other distribution like logistic. At this point, we know the parameters of the logistic or final distribution as we might call it or final output distribution.

We also know the mean and variance of the inner core normal. In this model, it doesn't actually matter what those are as long as the variance isn't zero. The reason is that the parameters of the “output” univariate distribution will undo any effect of the mean or non-zero variance of the normal.

So we say that the cumulative normal (of the univariate normal distribution) up to the simulated value x equals the cumulative distribution of the “output” distribution, say the logistic, whose value we call y. The distribution of y values doesn't depend on the mean and variance of the normal as long as we use the same mean and variance for x's cumulative distribution to transform x to y as we used to simulate x.

We thus solve for y by equating its logistic or whatever cumulative density to the cumulative density of x, with the same mean and variance for the cumulative of x as are used to generate x. And as long as that is done and x is univariate normal, it doesn't matter what mean and variance were used to generate x as long as the variance wasn't zero.

So we solve for y and that is now our output variable. The variable y might however be something now like the change in the logarithm of the stock price or index over some period of time, like a month.

Note that the transformation has to pick a specific time interval for it to be based on which has some specified logistic. It is possible to define a continuous in time output variable but it will only be logistic with specified parameters over some specific interval.

3.2 MVN

Let x be an n by 1 column vector. The 1 by n row vector x′ is given by
x′=(x₁, . . . , xₙ) (3.1)
We assume that x is multivariate normal, MVN, with probability density function

$$f ( x ; μ , Σ ) = \frac{1}{\sqrt{{( 2 π )}^{n} \vert Σ \vert}} {ⅇ}^{- \frac{1}{2} {( x - μ )}^{′} {Σ}^{- 1} ( x - μ )} \qquad ( 3.2 )$$

3.3 Univariate Distributions

For each xᵢ we transform to a variable yᵢ, defined by the following procedure. Let μᵢ and σᵢ be the parameters of the univariate distribution for xᵢ. Let Fᵢ(xᵢ; μ, σ²) be the normal cumulative distribution with mean μ and variance σ² for variable xᵢ. We have

$${F}_{i} ( {x}_{i} ; μ , {σ}^{2} ) = {\int }_{- ∞}^{{x}_{i}} ⅆ z \frac{1}{\sqrt{( 2 π ) {σ}^{2}}} {ⅇ}^{- \frac{1}{2} {( z - {μ}_{i} )}^{2} / {σ}^{2} \text{)}} \qquad ( 3.3 )$$

Let Gᵢ(yᵢ; η) be the cumulative distribution function of a single variable with parameter column vector η of dimension kᵢby 1. Let the corresponding probability density function be g(yᵢ; η), with appropriate modifications made for point masses, such as including a δ function in g. Let yᵢ be determined by the equation
Fᵢ(xᵢ; μ, σ²)=Gᵢ(yᵢ; η) (3.4)
We solve the above equation for yᵢ conditional on the parameter vector η after simulating the vector x including the value xᵢ. In this approach, Gᵢ can be any univariate distribution
   3.4 Discrete Time Simulation

We can simulate in discrete time, most simply when the time intervals are equal.

3.5 Combining with Other Variables

We can combine the variables generated in this manner with other variables, which themselves may follow a continuous time process. The vector x of MVN for tranforming to logistics can be generated as part of that process, and we can for example choose to make that subvector have a mean of zero and standard deviations of one over the time intervals at which we wish results.¹ This sub-vector then furnishes a vector of MVN for the above transformation. For the case of fixed time intervals for the desired logistics, we simply specify the corresponding logistic distribution parameters for an interval of that size and use the generated MVN over that period.
¹This is not really necessary.

### CHAPTER 4

### ESTIMATION OF PARAMETERS

For estimating parameters we have an inverse direction from simulation. In the case of simulation we start first with the simulation of the multivariate normal vector of variables first. Then we transform those to the individual output variables. This can be done by a transformation using cumulative density functions of the normal and any univariate distribution, such as a logistic.

In the case of estimation, we start with data that is already transformed so to speak by “nature” or the economy. Our job as experimentalists or as econometricians is then to reverse engineer nature. So we get from nature or the economy, variables that individually we identify as logistic or whatever.

We believe there is an inner core of correlation that is hidden by the logistic or univariate distributions of individual data series, such as the S & P 500, Ford stock price, etc.

We can't observe the correlation matrix directly nor estimate it directly from the observed univariate series, e.g. Ford stock price at month end, S & P 500 at month end from January 1950 to January 2003, or whatever period we use or data series we observe.

Because these invididual data series are logistic or whatever, we can't directly estimate the correlation matrix of them. The multivariate logistic is a very constrained distribution that we don't want to be restricted by. We might also want to use other univariate distributions than logistic.

So to uncover the hidden correlation of this collection of individual series, modeled by a collection of independent or seemingly independent univariate distributions, we want to transform each individual data series so that the transformed series is univariate normal. We then make the leap of faith, or assumption that these transformed series are in fact multivariate normal, MVN, and that we can estimate their correlation matrix by standard means for a MVN given a collection of individual normals that are further assumed to be multivariate normal. As is well known, that is not guaranteed, but as modelers of nature or the economy we make that our assumption because its easier to build a model. If that doesn't work we can try something else.

So as econometricians our first problem is to estimate univariate distributions for each series that comes to us from nature or the economy, the SPX, Ford, whatever. We in fact first transform this by using differences in the natural logarithms of the series or constructing the arithmetic returns. Because these transforms involve no parameters to be estimated we think of this as still being the data that comes to us from nature or the economy.

4.1 Estimation of Parameters

Suppose we are given a vector of data yₜ, t=1, . . . , T, where yₜ is a vector of dimension n by 1. For each i, we take the time series yₜᵢ, t=1, . . . , T, where yₜᵢ is the i-th component of yₜ. Given this data we can estimate a univariate distribution separately for each i. This can be done using standard univariate methods. Let the estimated parameters for each distribution be given by the vector ηᵢ, where ηᵢ is a kᵢ by 1 column vector.

Given these parameters, we can now transform to a distribution that is univariate normal. We discuss two ways to do this. One is to specify that the univariate normal has mean zero and variance 1. We then solve for xᵢₜ for t=1, . . . , T such that

$${\int }_{- ∞}^{{x}_{it}} ⅆ z \frac{1}{\sqrt{( 2 π )}} {ⅇ}^{- \frac{1}{2} {( z )}^{2}} = {G}_{i} ( {y}_{it} ; {η}_{i} ) \qquad ( 4.1 )$$

This gives us a set of vectors xₜ, t=1, . . . , T. We now estimate the correlation matrix among these using standard methods. Let this correlation matrix of the vector xₜ at any time point be denoted W.

We simulate with this approach a MVN with mean zero, and unit standard deviations with correlation matrix W. We then transform each yᵢ individually using Gᵢ(., bᵢ).

As an alternative, we could specify a vector μ for the MVN and a vector of standard deviations σ. These could be the values estimated in the sample.

As a short cut to estimate the correlation matrix, we can use the correlation matrix of the raw data. When dealing with some data, we may wish to take a transformation like the natural logarithm first. If we deal with stock data, for example we can first take the change in the natural logs of the stock prices and treat those as the y's. In this form, we may use the correlation matrix of the y's as a quick estimate of the correlation matrix of the normal distribution.

### CHAPTER 5

### STATISTICS

2.1 Univariate Logistic Distribution

For any y between −∞ and ∞, let the cumulative distribution of y given parameters α and β be

$$G ( y ; α , β ) = \frac{1}{1 + {ⅇ}^{- ( x - α ) / β}} \qquad ( 5.1 )$$

This can also be written

$$G ( y ; α , β ) = \frac{1}{2} ( 1 + tanh ( \frac{1}{2} ( x - α ) / β ) ) \qquad ( 5.2 )$$

G is the cumulative logistic distribution and y is said to be logistically distibuted or to have the logistic distribution.

5.2 Logistic Normal Conversion

To do conversion we equate the cumulative distribution function of the Normal to that of the Logistic.

$${\int }_{- ∞}^{{x}_{it}} ⅆ z \frac{1}{\sqrt{( 2 π )}} {ⅇ}^{- \frac{1}{2} {( z )}^{2}} = \frac{1}{1 + {ⅇ}^{- ( {y}_{it} - {α}_{i} ) / {β}_{i}}} \qquad ( 5.3 )$$

If we are simulating we simulate x with mean 0 and variance 1 and then use our model assumptions for αᵢ and βᵢ for series i, e.g. Ford or S & P 500 or whatever.

If we are estimating, we first estimate αᵢ and βᵢ from a time series of yᵢₜ and then we convert to x using the above formula given the observed value of yᵢₜ.

In both cases yᵢₜ is the return, log or arithmetic return, not the stock price or index value itself. For example x and y are both varying over −∞ to ∞.

The above normal has zero mean and variance 1 which may seem counter-intuitive. Why doesn't it have a mean and variance corresponding to that of the logistic?

The reason is it wouldn't matter. Suppose we use some μ and σ in the transformation

$${\int }_{- ∞}^{{x}_{it}} ⅆ z \frac{1}{\sqrt{( 2 π ) {σ}^{2}}} {ⅇ}^{- \frac{1}{2} {( z - μ )}^{2} / {σ}^{2}} = \frac{1}{1 + {ⅇ}^{- ( {y}_{it} - {α}_{i} ) / {β}_{i}}} \qquad ( 5.4 )$$

It won't make any difference once we look at the combined effect of simulation as well as conversion. As long as we simulate with the same μ and σ that we convert with, it doesn't matter what μ and σ are as long as σ is non-zero. We could use the values estimated from data, but we can also just use μ=0 and σ=1.

2-1 Proof

Suppose that we started with price data, then converted to differences of logs and estimated a logistic on that data. Suppose we also estimated the mean and standard deviation, and those had values μ and σ. We have the yᵢₜ,t=2, . . . , T, and we solve for xᵢₜ, t=2, . . . , T.

$${\int }_{- ∞}^{{x}_{it}} ⅆ z \frac{1}{\sqrt{( 2 π ) {σ}^{2}}} {ⅇ}^{- \frac{1}{2} {( z - μ )}^{2} / {σ}^{2}} = \frac{1}{1 + {ⅇ}^{- ( {y}_{it} - {α}_{i} ) / {β}_{i}}} \qquad ( 5.5 )$$

We then estimate our variance-covariance matrix W. However, for now lets pretend we have just one series i. Now we come to the simulation point. And imagine that we simulate uᵢₜ using a normal distribution with μ=0 and σ=1.

Now we could calculate
xᵢₜ=μ+σuᵢₜ (5.6)
We now calculate the cumulative distibution function, F using

$$F = {\int }_{- ∞}^{{x}_{it}} ⅆ z \frac{1}{\sqrt{( 2 π ) {σ}^{2}}} {ⅇ}^{- \frac{1}{2} {( z - μ )}^{2} / {σ}^{2}} \qquad ( 5.7 )$$

We can substitute for xᵢₜ as

$$F = {\int }_{- ∞}^{μ + σ {u}_{it}} ⅆ z \frac{1}{\sqrt{( 2 π ) {σ}^{2}}} {ⅇ}^{- \frac{1}{2} {( z - μ )}^{2} / {σ}^{2}} \qquad ( 5.8 )$$

Now to calculate this integral, we tranform z to a standard normal. We do this by setting
v=(z−μ)/σ (5.9)
Making this transformation, we find that

$$F = {\int }_{- ∞}^{{u}_{it}} ⅆ z \frac{1}{\sqrt{( 2 π )}} {ⅇ}^{- \frac{1}{2} {z}^{2}} \qquad ( 5.10 )$$

Now this is the same thing as if we had just simulated uᵢₜ and then used this cumulative distribution to calculate F.

The value of yᵢₜ depends on F, αᵢ and βᵢ not on how F was calculated, as long as it produces the same F. So if we simulate u as mean 0 variance 1, and then transform u to some x which has mean μ and σ and calculate F using the same μ and σ its the same as if we calculate F using u and using μ=0 and σ=1.

2-2 Extension to Other Distributions

The proof just given that the conversion from the normal to the non-normal distribution was independent of the normal's mean and standard deviation as long as the same parameters of mean and standard deviation are used to generate the normal deviates as to do the transformation did not rely on the characteristics of the logistic, and the same proof applies to any non-normal distribution.

5.3 Gamma Distribution

Reference Morris DeGroot Probability and Statistics p 236. The probability density for the Gamma Distribution is

$$g ( x \vert α , β ) = \frac{{β}^{α}}{Γ ( α )} {x}^{α - 1} {ⅇ}^{- β x} \qquad ( 5.11 )$$

for x>0 and 0 otherwise. Here Γ(α) is the Gamma Function, which generalizes the factorial, Γ(n)=(n−1)!.

This gives us a 2 parameter distribution. We can compute the cumulative distribution function as

$$\begin{matrix}G ( y \vert α , β ) = {\int }_{0}^{y} ⅆ xf ( x \vert α , β ) \\ So that & ( 5.12 ) \\ G ( y \vert α , β ) = {\int }_{0}^{y} ⅆ x \frac{{β}^{α}}{Γ ( α )} {x}^{α - 1} {ⅇ}^{- β x} & ( 5.13 )\end{matrix}$$

We then convert from normals to this Gamma by first simlating a normal deviate u with cumlative density

$$F ( u ; μ , {σ}^{2} ) = {\int }_{- ∞}^{u} ⅆ z \frac{1}{\sqrt{( 2 π ) {σ}^{2}}} {ⅇ}^{- \frac{1}{2} {( z - {μ}_{i} )}^{2} / {σ}^{2} )} \qquad ( 5.14 )$$

and then converting to y such that
G(y|α, β)=F(u; μ, σ²) (5.15)
We have to interpret the results somewhat differently though. Since y is between 0 and ∞ it can be interpreted as the new price divided by the old price. In the case of the Logistic Distribution, we interpreted y as the change in the log of the stock price. Now we have to interpret it as the new stock price divided by the old stock price.
   5.4 Beta Distribution

The beta distribution has probability density function

$$g ( x \vert α , β ) = \frac{Γ ( α + β )}{Γ ( α ) Γ ( β )} {{x}^{α - 1} ( 1 - x )}^{β - 1} \qquad ( 5.16 )$$

for 1>x>0 and 0 otherwise.

To represent stock returns with this distribution it is necessary to convert the stock return or stock price to a variable between 0 and 1 and vice versa. We can do this by taking a lognormal variable and converting it into a unit deviate by calculating u from x by
u=F(x; μ^{T}, σ^{T}) (5.17)
or given x, solving for u. The superscript T reminds us these are the transformation parameters. One choice is μ^{T}=0 and σ^{T}=1.

Here F is the cumulative distribution of some lognormal variable. This can differ from the normal used for the generation of the random normals.

If we generated a normal x, converted that to u and then from that u to y for the Beta and then from that y back to x′ as a normal, then we would have that x′ was a normal determined essentially by the initial x directly. So we need a different method to generate a distribution of data.

4-1 Alternative Generation of Multivariate Vector

We can instead use the univariate distributions of logistic, beta, gamma, etc and generate uniform deviates uᵢ. We can then transform these to normals xᵢ. We can then take a linear combination of these xᵢ, yⱼ=ΣᵢRⱼᵢxᵢ, where R is some matrix. Note the dimension of the x vector can be larger than the dimension of the sub-vector of y we wish to use. We can now treat the yⱼ as changes in logs of stock returns. Or we could transform them to be between 0 and ∞ and interpret those as ratios of prices.

In this approach we have a fundamentally discrete time generation process.

### CHAPTER 6

### REGIME SWITCHING

6.1 2 Regime Switching Model Lognornmal

For this model, let the parameters be μᵢ and σᵢ in state i, i=1,2. The parameters of the model shift at random times. Let ρᵢⱼ be the transition rate per unit of time of going from state j to state i.

The lognormal model is
dx=μᵢdt+σᵢdz (6.1)
when in state i.
6.2 Estimating the Parameters

The parameters are estimated using maximum likelihood as in Hamilton, Time Series Analysis, Chapter 22. See for example Mary Hardy's North Ameican Actuarial Journal paper for an application to the two state regime switching lognormal.

6.3 Estimating Initial State

The initial state can be represented as known in one of the regimes, or as a probability density over them.

3-1 Maximum Likelihood

Can use the maximum likelihood method in Hamilton. This produces the probability density.

3-2 Trailing Data

We can also use trailing data, especially daily data if available. We estimate the parameters in the previous N days, and then use a simple comparison to the two states of the model and use the one that is closest. Alternatively, a weight can be given to each of the possible states, e.g. if the trailing vol is 20 percent and there are two vol states of 15 and 25 percent, one could use a weighted average, computed in standard deviation or variance for example as the measure.

6.4 Regime Switching Non-Normal Models

We can generalize the discussion of the last section to cover the other univariate models besides the lognormal. Let the model have a parameter vector η, with elements ηᵢ, i=1, . . . , n₇₂, where n_{η} are the number of elements in the vector η. Let there be nᵣ regimes of the parameters or discrete parameter sets.

Using the same methods as for the lognormal model other models can be estimated. This is done using maximum likelihood as in Hamilton.

6.5 Advantages of Regime Switching

5-1 Data Description

There Regime Switching Model (RSM) describes the effect in data of periods of different values of parameters. Periods of high volatility in particular are important in modeling indices, especial equity indices. The Regime Switching Model does more than model the fat tails of the data, it also models the tendency for one fat tail event to be followed by another, i.e. a switch in regime in which large losses or gains are more likely. This is important to option writers because such gains or losses have a non-linear effect on the option price. This non-linear effect and the probability of greater price changes then results in diffrent prices for the options, so that their expected return in the risk neutral probability is the same. In particular, the optionality of the option, its convexity is worth more when volatility is higher. This leads to a higher price of the option, put or call.

5-2 Risks to Option Writers Modeled by Regime Switching

Option writers, such as by variable annuity sellers, have the risk that volatility will change from what it is or they expect. When this happens, the Greek's of the options written change. This means that after a change in parameter values, the change in option prices for a given change in the stock price will be different. As a consequence, hedges set up to match Greeks, i.e. to match risk of the asset portfolio to the liability portfolio will no longer match. This is because the asset portfolio was chosen for a given set of Greeks. When the parameters change the asset and liability portfolio options all change in their Greeks, but because the Greeks are non-linear functions of the parameters and the mix of options in the asset and liability portfolio are different the options will change their prices from the parameter change and their Greeks, so that there is a discrete change in price from the parameter change and a discrete change in Greeks. This can cause a loss itself and also means the asset portfolio no longer hedges the liability portfolio.

The changes in prices and Greeks from the parameter change is a risk that can be analyzed using the regime switching model. Moreover, the change in hedge portfolio after the jump to one more appropriate to the new regime of parameters can be analyzed using simulations based on the regime switching model. One can estimate the cost for example of changing the hedges after a parameter change. Moreover, one can estimate the cost of the parameter changes and develop a portfolio to partially hedge this.

6.6 Canadian and US Insurance Regulation

Canadian and draft US C3 Phase II regulations for capital have a simulation option or requirement (use of tables is allowed in Canada). This does not require use of regime switching, although the calibration table in Canada was developed using regime switching analysis. Distributions with fat tails meet the calibration table with parameters that don't have super fat tails. By using a high enough volatility the lognormal will meet the calibration table. The calibration table requires the probability for large returns or large losses of specified size to exceed certain minimum probabilities. If one uses a lognormal and increases its volatility to fit the table, to meet all the points one needs a very large volatility, so that one exceeds the required probability for several of the points in the table. With the regime switching or other fat tailed distributions one can come closer to just matching each point in the calibration table.

### CHAPTER 7

### ESG

7.1 DMRP

Let u and θ follow the process
du=k₁(θ−u)dt+σ₁dz₁dθ=k₂(θ₂−θ)dt+σ₂dz₂ (7.1)
under realistic probability. The correlation between dz₁ and dz₂ is ρ. Let the risk neutral version be
du=k′₁(φ−u)dt+σ₁dz₁dφ=k′₂(φ′₂−φ)dt+σ₂dz₂ (7.2)
Where the variable φ is related to θ by a linear transformation. The correlation between dz₁ and dz₂ is still ρ and the values of σ₁ and σ₂ are the same in real as risk neutral as is required from no-arbitrage.

The instantaneous short term interest rate is
r=e^{u} (7.3)
The prices of bonds are solved from

$$\frac{1}{2} {σ}_{1}^{2} {B}_{uu} + {B}_{u} {κ}_{1}^{′} ( ϕ - u ) + \frac{1}{2} {σ}_{2}^{2} {B}_{ϕϕ} + {B}_{u ϕ} {ρσ}_{1} {σ}_{2} + {B}_{ϕ} {κ}_{2}^{′} ( ϕ - u ) - {ⅇ}^{u} B + {B}_{t} = 0 \qquad ( 7.4 )$$

The parameters of the real and risk neutral processes are estimated from historical data over different time periods starting in the 1950's to date for U.S. Parameters for other countries and for the Euro are also available as well as dual linked currencies such as US Yen or Euro Yen in which the exchange rate is part of the state vector v and multiple sets of u, θ or u, φ are used for each economy.

In simulating real probability scenarios we can simulate u and φ but with realistic probability parameters for this process, yet a 3rd process from the above. Given u and φ we then calculate bond prices and yields. Alternatively, we can simulate u and θ and then calculate φ and then calculate bond prices.

7.2 ESG™ Simulation

We first consider the case without regime switching. Let the vector v be m by 1, and let its elements be v₀=u, v₁=φ, let vᵢ₊₁=xᵢ, for i=1, . . . , n where n is the dimension of the x vector, and we index x starting from 1. We now form the process
dv=(b+Av)dt+Gdw (7.5)
where b is m by 1, A is m by m and G is m by m. The vector dw is m by 1 and is a vector of mean 0, variance dt independent Wiener processes. We simulate v over some set of time intervals, which we suppose for simplicity are of equal size, Δt. We assume we start at t=0, and generate a time series vₜ, t=0, . . . , T. So we simulate v₁, . . . , v_{T} and we start with v₀. For stock return elements, i>1 vᵢ₀=0 and for the interets rate model we use v₀₀=u and v₀₁=θ. Here the first index of v is the time index t, and the second index the index j for the vector component.

The first two elements of b and the first 2 by 2 sub-matrix of A are formed so as to replicate the DMRP process above. All other elements of A and b are zero.

The correlation matrix GG′ is estimated for the joint correlation matrix of u, θ and x, i.e. v.

We now simulate v and for each element of x, we have xᵢ=vᵢ₋₁ suppressing the t index, and remembering we are indexing x starting with 1 and v starting with 0.

We now convert each xᵢ to yᵢ using the univariate distribution for yᵢ. This can be normal or logistic or some other univariate distribution. We use the appropriate parameter vector bᵢ to do this, taking care our parameters are approriate for the time interval Δ. As proven earlier it doesn't matter what the mean and variance of the xᵢ are at each t, as long as we use the same ones for the conversion as for the simulation. We can in fact just use unit normals used in generating the w[t] vector.

7.3 ESG with Regime Switching

We have the vector of continuous variables
dv=(b+Av)dt+Gdw (7.6)
In addition to this is the state index s, which we interpret as a set of a finite number of states. We have a mapping from s to b, A and G, assigning for each s, b(s), A(s) and G(s). Different values of s can then correspond to the different paramters of the univariate models for each index. We have a process on s, of the form ρ(s′, s)dt where ρ(s′, s) is the transition rate per unit time to go from state s to state s′. In addition the transformation functions from v to y are indexed by s in addition to their other parameters so y=h(v, s, t) is the transformation function from v to y contingent on state s.
   7.4 Indices and Interest Rates
   4-1 Risk Neutral

Suppose we have a stock index with cumulative total return value V. So at time t=0, we have V=0.

Consider the case that the index's returns are lognormally distributed. The risk neutral process on V is
dV=rVdt+σVdz (7.7)
where dz is correlated to the other elements of the vector y.

Over a finite interval from t to t+h, we have

$$\begin{matrix}ln V [ t + h ] - ln V [ t ] = \int [ r - \frac{1}{2} {σ}^{2} ] ⅆ {t}^{′} + \int σ ⅆ z & ( 7.8 ) \\ ln V [ t + h ] - ln V [ t ] = \int r ( {t}^{′} ) ⅆ {t}^{′} - \frac{1}{2} {σ}^{2} h + \int σ ⅆ z & ( 7.9 )\end{matrix}$$

where we assume that σ is constant over the time interval h.

If r(t′) was constant, then we could do the integral on r and get

$$ln V [ t + h ] - ln V [ t ] = r ( t ) h - \frac{1}{2} {σ}^{2} h + \int σ ⅆ z \qquad ( 7.10 )$$

However, for the DMRP model, r(t) is not constant. Instead it is a random process over the time interval. At time t, we want the prospective distribution of V[t+h] at the end of the time interval [t,t+h] conditional on information at time t. We can approximate the above process in risk neutral by

$$ln V [ t + h ] - ln V [ t ] = ζ - \frac{1}{2} {σ}^{2} h + \int σ ⅆ z \qquad ( 7.11 )$$

where ζ is the yield on a bond from t to t+h, conditional on the state vector y at t. So
e^{ζh}=B(t, t+h, y) (7.12)
where B(t,t+h,y) is the zero coupon bond price at time t that matures at time t+h conditional on the state vector y at time t.
4-2 Realistic Probability

We can write the return on the index in realistic probability as

$$ln V [ t + h ] - ln V [ t ] = a + b ζ - \frac{1}{2} {σ}^{2} h + \int σ ⅆ z \qquad ( 7.13 )$$

Where a and b are constants estimated from a regression or by theory. For example, one could use the CAPM values. This could be represented as
E[R]=ζ+β(E[Rₘ]−ζ) (7.14)
where β is the CAPM beta of the index relative to some market index and ζ is the yield over the interval h on a zero coupon bond, and E[Rₘ] is the expected return on the market index.

So for the CAPM one chooses
a=βE[Rₘ] (7.15)
b=1−β (7.16)
4-3 Bond Index

The relation of bond indices to interest rates is discussed in a separate section.

7.5 ESG Estimation

5-1 Correlation Matrix

To estimate the correlation matrix of the ESG, we proceed along the lines of Chapter 2, but now include past values of u and θ estimated from the yield curve on past dates to get these values and then estimate the correlation matrix of u, θ and x where x is the state vector y not including u and θ.

As before, we estimate each time-series in x, e.g. S & P 500 or Ford stock price first as a univariate distribution, e.g. Logistic and then use the estimated parameters to transform to the normals using the cumulative distribution method.

Suppose we have a set of indices, i=1, . . . , N_{I}. Let the total return on each index over a set of time intervals be v(i, tₖ) for index i at time tₖ. We use the total return from tₖ₋₁ to tₖ.

$$ρ ( i , j ) = {\sum }_{t} [ v ( i , t ) - \overline{v ( i )} ] [ v ( j , t ) - \overline{v ( j )} ] / D \qquad ( 7.17 )$$

D is an appropriate divisor, such as Nₖ or Nₖ−p where p is the number of parameters estimated and Nₖ is the number of time points for which there are total returns. Note if we start with index values this is one less than the number of time points for which we have index values. Here \overline{v(i)} is the average of v(i, tₖ), k=1, . . . , Nₖ.

7.6 Index Simulation

A set of N_{I} indices are selected. The state vector y is now N_{y}=2+N_{I} in dimension, unless there are additional elements in it.

6-1 Input

The current value of the index is usually input as 1 instead of its actual numerical value.

6-2 Process

The change in the index is lognormal in the simplest case. We find the change in the log of the index as the sum of its expected change and its random change. These come out of the Vector Autoregression (VAR) model on the vector y.
dy=(b+Ay)dt+Gdw (7.18)

Here, b, y and dw are vectors of dimension N_{y} by 1. A and G are matrices of dimension N_{y} by N_{y}.

Each of the index returns is lognormal conditional on the starting value of y. We can however, use the regime switching model to augment this.

6-3 Output

The output is the log of the index value or its transformed value.

7.7 Estimation of Index Returns

Index returns are estimated using past data. A set of index returns over a period of time are converted into log returns by transformation. These are then correlated to each other and to the u and θ variables of the model. The standard assumption is to assume that there is no dependence on y in this return, i.e. the A matrix has zeros in the row corresponding to the index.

SPX data at monthly intervals has been estimated in this form, as well as other indices on an experimental basis.

7-1 Alternatives on Index Return Modeling

It is possible to relax the constant returns assumption for indices and estimate the corresponding row of the A matrix.

Another approach is to have a relationship from yields to the expected return. A simple one is a spread over the 3 month yield, although several yields can be modeled this way. The coefficients could be estimated by a regression.

Altering the volatility assumptions can be done with the regime switching.

7.8 Bond Index Modeling

Bond indices can be modeled in the same manner as equity indices. We consider some alternatives to this below.

8-1 Bond Portfolios

A set of bond prices can be computed and output for each time point in each scenario. From these total returns can be calculated. Given a set of portfolio weights, these returns can be combined into a portfolio return. One or more such portfolios can be calculated.

We can calculate a portfolio return as

$${R}_{p} = {\sum }_{i} {w}_{i} {R}_{i} \qquad ( 7.19 )$$

where wᵢ are the portfolio weights and the Rᵢ are the portfolio returns.

One assumption on the wᵢ is a set of constants. Another assumption is that the amount invested in each bond is constant. Interest is then allocated to that bond or the portfolio. This assumption is more complicated to model. When a bond matures it repurchases into the same maturity is usually preferable to the portfolio or a fixed new purchase portfolio.

A modeled portfolio return can be a weighted average of such portfolio returns and other equity like indices.

$${R}_{a} = {\sum }_{i} {w}_{i} {R}_{i} \qquad ( 7.20 )$$

where now the Rᵢ are some combination of equity and bond portfolio returns. One of these can be a “residual” or selected return. The portfolio weights against constructed benchmark bond yield portfolios can be estimated by regression.
8-2 Estimation

This model requires estimation or selection of the bond portfolio weights from bonds as well as other portfolio weights. A residual return can be used to be estimated from data.

A set of portfolio weights could be selected based on average portfolio composition over some period of time.

7.9 Bond Portfolios Detail

9-1 Inputs

The portfolio weights of a set of bond portfolios in terms of primary bonds. The maturity dates, spreads and other information on these primary bonds.

The portfolio weights from each output index in terms of the bond portfolios.

A “residual” return portfolio in terms of its mean, standard deviation of return and correlation to other elements of the state vector y.

The mean could in theory be a function of y or of other variables such as yields of bonds (or even portfolios).

9-2 Process

The residual return is calculated as part of generating the vector y.

The bond portfolio returns are generated by first generating prices of the bonds, then calculating their returns and then combining these into the bond portfolio returns.

The residual return and bond portfolio returns are combined using the weights for each index.

The weights to form the bond portfolio returns and the residual return might vary with y or other inputs or outputs, but in the simplest case would not.

9-3 Output

The value of the index.

7.10 LIBOR Modeling

LIBOR can be modeled as the primary yield curve. Treasuries can then be modeled if needed by a linear regression. Alternatively, one can go from such a treasury linear regression to LIBOR.

In practice it is often sufficient to start with the LIBOR-swap curve and to modify the ultimate target rate from treasury parameters by increasing it modestly, e.g. by 50 bp. The generated LIBOR-swap curve can then be used to construct a treasury curve by subtracting the initial spread from treasury to LIBOR-swap.

If LIBOR is used as the benchmark yield curve, LIBOR bond portfolio returns will more closely track an investment grade corporate bond portfolio.

10-1 LIBOR Data

If LIBOR-swap data is provided, the LIBOR-swap rate process can be better estimated than simply modifying treasury parameters subjectively.

### CHAPTER 8

### NOTATION

8.1 Basic Parameters and Variables

1-1 n

The number of individual data series, e.g. S & P 500, Ford, etc. These are numbered 1 to n.

1-2 T

The number of time periods, numbered from 1 to T.

1-3 x

An n by 1 vector from a multivariate normal distribution.

1-4 y

An n by 1 vector of variables transformed from x. These are the observables.

1-5 E

Correlation matrix that is n by n. Used to do simulation, and is the theoretical unobserved true correlation matrix of the x vector.

1-6 W

This is the estimated correlation matrix. It is used to do the actual simulation as if it was the theoretical correlation matrix when the software system is used in practice.

8.2 Returns

2-1 Log Return

Given any time series, Vₜ, t=1, . . . , T, such as a price, or other variable which is non-negative, we can define its log return as uₜ
uₜ=lnvₜ−lnvₜ₋₁ (8.1)
for t=2, . . . , T. We thus “lose” a data point at t=1.

So for example, yᵢₜ might be the change in the natural logarithm of the change of Ford's stock price. We calculate it from the observed stock prices, Pₜ and Pₜ₋₁ as
yᵢₜ=lnPₜ−lnPₜ₋₁ (8.2)
where i corresponds to Ford, say i=1 was Ford.

To go the other way, to get Pₜ given yᵢₜ we calculate
Pₜ=Pₜ₋₁e^{y}^{ᵢₜ} (8.3)

We have to know Pₜ₋₁. If we are simulating we have to know P₀ say and then we can simulate for later t using yᵢ₁, . . . , y_{iT}.

### CHAPTER 9

### BEST MODES: RS-VAR

0-2 Introduction to a VAR with Regime Switching

The following is given as an introduction to the idea. We shall however, use the definitions that appear later to define this. Suppose we have two state vectors, y and v. We have the vector of continuous variables
dv=(b+Av)dt+Gdw (9.1)

In addition to this is the state index s, which we interpret as a set of a finite number of states. We have a mapping from s to b,A and G, assigning for each s, b(s), A(s) and G(s). Different values of s can then correspond to the different paramters of the univariate models for each index. We have a process on s, of the form ρ(s′, s)dt where ρ(s′, s) is the transition rate per unit time to go from state s to state s′. In addition the transformation functions from v to y are indexed by s in addition to their other parameters so y=h(v, s, t) is the transformation function from v to y contingent on state s.

0-3 RS-VAR

Definition 9.1 (Discrete RS-VAR) Suppose we have a discrete variable s, that varies over some set, which can be finite. This might be 1 to p or 0 to p-1. The variable s can be thought of as a state or a regime. The transition probability matrix for transition from a state s to s′ is given by φ(s′, s). (Note that the order can appear differently in some treatments.) The standard requirement is that the sum over different final states s′ is 1 for any initial s′. Each element of φ(s′, s) must be non-negative, but zero is allowed. There is a mapping from s to n by 1 vectors μ₀(s), and n by n matrices A(s) and G(s). The n by 1 vector y follows the process
y[t]−y[t−1]=(μ₀[s]+K[s]y[t−1])Δt+Σ[s]t \sqrt{Δt} (9.2)

The time interval can vary with time t. It is also possible to allow μ, K, Σ to depend on t as well as s.

Definition 9.2 (Continuous RS-VAR) The regime s can make a transition at any point t in continuous time. The probability (conditional on a transition occurring) of a transition from s to s′ is ζ(s′, s). The probability of a transition out of state s is η(s)dt. In this case, we require that ζ(s, s) =0. We also require that the ζ(s′, s) are non-negative and sum to one.

There is a vector of state variables, v, that follows the process
dv=(b[s]+A[s]v)dt+G[s]dw (9.3)
where v is an n by 1 vector of variables, b is an n by 1 vector of parameters, A is n by n, G is n by k and dw is k by 1. The vector dw is a vector of Wiener processes, with mean 0 and variance dt.

Definition 9.3 (Mixed RS-VAR) The state transition can be fixed at time nodes and follow a discrete process as in the discrete Regime Switching portion of the discrete RS-VAR. From one time node to the next, the process is then a continuous-time VAR.

Definition 9.4 (RS-VAR) A RS-VAR is either a discrete RS-VAR or a continuous RS-VAR.

Definition 9.5 (Essential RS-VAR) An RS-VAR that is not a VAR is called an Essential RS-VAR or E-RS-VAR.

0-4 Discretization Method

Definition 9.6 (Discretization method) For a continuous-time stochastic process unless otherwise specified the discretization method shall mean the method obtained by restating the process as a discrete time process for all variables using the already determined values from the previous time node to calculate all new values at the next time node. In terms of equations, all variables on the right of the equal sign are understood as from the previous time noe and all on the left as the next time node. Note that dt becomes Δt and Wiener or diffusion type elements, commonly denoted by dw, dz, etc become \sqrt{Δt} times an appropriate random variable. Those variables may be correlated or uncorrelated as the convention, text, or references indicate. In general it is to be understood they can be correlated with some correlation matrix. They are to be understood as mean zero, with individual variable variances of one and some correlation matrix. That may also be expressed in terms of a Cholesky Decomposition of a variance-covariance matrix. Inputs and outputs are to be understood as the appropriate set of varibles and parameters for the convention used. The discretization method is a fall back in case no other method is specified, available, in the prior art or literature. Each claim, element of the specification, etc. that can be so understood includes this method as within its meaning except where indicated otherwise or it is clear by the context.

0-5 FX

In an FX model, the parameters can vary with regime. This can be done with all the parameters in the FX model considered earlier in reference to the MFC-FX model. A multiple set of currency exchange rates can be modelled with regime switching parameters.

0-6 Defining Regimes

A single discrete index can be used even if we start with multiple discrete indices. Suppose there are n indices, and for the i-th index it can have mᵢ possible values. These need not be integers but we can always map them onto integers. We then have
N=Πᵢmᵢ (9.4)
possible states. The product is over i=0 to n-1 or i=1 to n depending on our indexing scheme. Other schemes are possible as well, of course. It may be that there are a smaller number of possible states because some combinations can't occur. We can still treat those as states but the probability to go to them is zero. If we don't start in one, we won't go to one. We could also define the probability of exit from such a state to be one. Let M≦N be the accessible states. We can then index the actual states s from 0 to M-1 or 1 to M or some other set of values, which need not be integers but are more convenient that way, especially for computer programming.
9.1 RS-VAR DMRP

The specific case of the RS-VAR DMRP is given as follows. We have as before, the DMRP as:
du=k(θ−u)dt+σdz₁ (9.5)
dθ=k₂(θ₂−u)dt+σ₂dz₂ (9.6)

We can then make the coefficients functions of a regime index s, where the regime index follows a pure regime switching process in discrete or continuous time or with discrete time points at which it can change. Here the short rate is r=e^{u}. Note one can introduce a time-dependent factor, so that r=e^{u}α(t).

Individual yields can be modeled through solving the DMRP. One can also have processes on “yield residuals” such as an AR(1) process or joint VAR on these yield residuals as well. These can be fit to the initial yield curve and decay according to such a process, or a straight line decay over a finite time interval or some deterministic pattern of decay or that times a random residual which follows an ARIMA process or Vector ARIMA for a family of yields.

These methods can be used for any of the RS-VAR's considered here, as can the time-dependent multiplier for the short rate, regardless of the transformation method or time-dependent coefficients in any of the functions. See the prior art for many examples of this.

We can also imbed this model into a RS-VAR of n-dimensions

9.2 Auxiliary Processing

After the production of state variable files or data, and/or yield/price curve files or data as scenarios or grids or otherwise, additional scenario files and other data can be produced. This can use transformations and functions involving multiple variables at once from all of these, as well as lagged values and using Generalized Financial Variables as defined elsewhere in this document.

9.3 Parameter Estimation

This can be done by a variety of means. These include Generalized Method of Moments(GMM), Maximum Likelihood (ML), and also the use of judgement, stylized facts, and other methods. See the references and the references cited therein for the application of these methods in finance and to VAR's, regime switching and in some cases RS-VAR's.

9.4 Other Data Institution

An institution's other data can be combined with the data for the stochastic process for performing analysis, producing reports, making preparation for a transaction, and executing or attempting to execute a transaction. A transaction might also include a bid or ask. This may involve transmitting data, or performing a transaction or action over or though or by the use of the internet or similar network or electronic or digital methods. See also the section on individuals, which may include institutional use for its customers, prospective customers or individuals it wishes to transact with. These can be combined as well.

9.5 Other Data Individual

The stochastic process can be used by the individual, an adviser, an institution for which they are a customer or prospective customer or that desires to make some transaction with the individual. This can be combined with data for that individual or data that might be used for a representative individual, illustration, benchmark or profile of that individual or of one or more categories used to prepare the analysis, quote, transaction, etc. for or with the individual. This may involve transmitting data, or performing a transaction or action over or though or by the use of the internet or similar network or electronic or digital methods.

### CHAPTER 10

### BEST MODES: DEFINITIONS

Definition 10.1 (Computer) A device with one or more of the following elements
1. Hard Drive
2. Memory
3. Central Processor Unit(s)
4. Electronic Chip
5. Pathways for conducting electrons encoded into a physical object.
6. Cathode Ray Tube
7. Printer whose output is controlled by digital media, software, or electrons
8. Computer chips such as Intel 80286 architecture based, or its descendants, or its predecessors, or its competitors.
9. Computer chips such as Intel 80386, 80486, Pentium, Pentium II, etc.
10. Devices incorporating these or similar chips.
11. Devices capable of operating Microsoft operating systems, including DOS, Windows 95, 98, 2000, NT, XP, and ones incorporating the code or methods or replicating some of the operation of these systems.
12. Devices capable of operating LINUX, UNIX or similar systems.
13. Devices capable of operating operating systems used for DEC, HP, Apple, IBM or similarly marketed computers from personal computers to mainframes.
14. Devices capable of being operated by similar or competing operating systems.
15. Devices connected to devices operated by the aforesaid or similar operating systems.
   cite some handbooks and product numbers?? Computing device and other synonyms shall be understood as referring to this definition.

Definition 10.2 (Internet) Means for transmitting electronic information involving one or more of the following elements
1. Transmission Control Protocol: TCP
2. Internet Protocol: IP
3. Network protocol
4. Cables to conduct electrons between computers
5. linked computers
6. methods to link computers
7. devices to link computers
8. Any network part of which is appropriately documented by the CISCO Internetworking Technology Handbook.
9. Any network capable of performing a task also performed by the foregoing.
   See CISCO Documentation Internetworking Technology Handbook, especially Chapter 30, Internet Protocols.

Network and other synonyms shall be understood as referring to this definition.

Definition 10.3 (Equation) In the context of forming computer or network algorithms, an equation shall have the following meaning. Except where an implicit method is indicated an equation shall have the same meaning as in a programming language like C, C++, FORTRAN, or higher or lower level computer languages. It shall mean the machine or the process as appropriate to the context of the claims for computer related processes, machines or patentable subject matter as in patent office guidelines, 705 type patents, and decisions of the CAFC or other courts. Where an equation is used for an implicit algorithm it means the calculation of the disrepancy of the equation or deviation as appropriate to an implicit algorithm. In the case of stochastic differential equations or partial differential equations or other equations requiring an algorithm, a standard algorithm or an algorithm in the patent shall be understood as appropriate means unless the context clearly indicates some other meaning.

Note 10.1 (Diagrams as Computer or Process Diagrams) In the context of forming computer algorithms or stating the use of a computer or network a diagram shall have the following meaning. In such context, a diagram or several diagams shall be understood as referring to processes involving computers, machines or other patentable processes, machines, methods, etc as are common in 705 type patents, patent office guidelines, decisions of the CAFC and other courts.

Definition 10.4 (Function) In the context of forming computer or network algorithms, a function shall have the following meaning. A function in this context means as in C, C++, etc. a set of operations or a computer function or subroutine and the appropriate encoding of it onto a computer. In some cases, an implicit algorithm is indicated by the context or the prior art of this patent.

Note 10.2 (References as Computer Calculations) Where references (i.e. texts like a book or article) are referred to, their use of equations, functions, calculations, algorithms, etc. when used as part of the specification or patent shall be understood as referring to the definitions of function, equation, calculation, etc. given here.

Definition 10.5 (Calculation) In the context of forming computer or network algorithms, calculation means using a machine programmed for that purpose including a computer or if appropriate a computer.

Definition 10.6 (Variable Transformations) Given a vector v,i=0, . . . ,n-1, we could make a set of transformations such as
1. xᵢ=e^{v}^{ᵢ}
2. xⱼ=vᵢ²
3. xₖ=ln(|vᵢ|)
4. xₖ=cos(vᵢ)
5. xₖ=sin(vᵢ)
6. xₖ=tan(vᵢ)
7. xₗ=ln({square root over (|vᵢ|))}
8. xₚ=vᵢ^{α}, α real where this is defined.
9. xₚ=|vᵢ|^{α}, α real where this is defined.
10. xₚ=I(vᵢ>0)
11. xₚ=sgn(vᵢ), where this is the sign of vᵢ,
12. etc.
13. recursive functions using polynomial, rational, analytic, indicator, and inverse function or relations, integral, differences, weighted sums, etc.

Note that in the above, the index in the x vector need not correspond to that of the v vector. The repetition of the same index in the above is not relevant. It means a separate transformation. The above can be real functions, from reals to reals, where defined or from complex to complex where defined. In the latter case, there may be poles, branches and a Riemann Surface. We can also make transformations involving several of the v's at the same time.
1. r=v′Qv+β′v+α
2. r=e^{v′Qv+β′v+α}
3. Multivariate Copula
4. etc.
5. recursive functions using polynomial, rational, analytic, indicator, integral, differences, weighted sums, etc.
   Here xₗ, etc. r could be an interest rate, default rate, prepayment rate, lapse rate, expense, etc. The parameters above can themselves be functions of the variables. Complex numbers or transforms to complex variables or other objects such as vectors or matrices of complex numbers, or sequences or series of them, etc. are allowed. The variables themselves can be complex even in the RS-VAR.

We can extend the state vector of say a RS-VAR by using lagged elements, using an integral or sum of functions of the elements of the RS-VAR, and past or current values of those or other variables.

Definition 10.7 (GFV: General Financial Variables) A GFV is any of the variables from the following list
1. Any variable appearing in
   (a) A public report of a company relating to it, such as
      i. Annual Report
      ii. Income Statement
      iii. Statement of Changes in Financial Position
      iv. Notes, Appendix or reference to any such statement.
      v. The same prepared with a different system of accounting including mark-to-market accounting, mark-to-model accounting, or mixtures of them.
   (b) A filing with
      i. SEC
      ii. Federal Reserve
      iii. State Insurance Commissioner
      iv. IRS
      v. similar entity
      vi. etc.
      vii. The same prepared with a different system of accounting including mark-to-market accounting, mark-to-model accounting, or mixtures of them.
   (c) Any variable prepared in accordance with any of the following accounting methods
      i. US GAAP
      ii. Canadian GAAP
      iii. GAAP of any country or union of countries such as the European Union
      iv. International Accounting Standards
      v. US Statutory Accounting based on NAIC,AAA, SOA, CAS, CIA, or other actuarial organization or state insurance or Canadian federal or provincial Insurance regulation.
      vi. The same for a European country or politicial, economic or other division thereof.
      vii. Any of the above using a modification involving mark-to-market or mark-to-model or a mixture of them.
   (d) etc.
2. Managerial Accounting or internal financial analysis.
3. Financial analysis variables of an external group, such as those created in the course of preparing the following. A variable
   (a) Prepared for or by a rating agency
   (b) Prepared for or by a broker or dealer in securities, derivatives, exchange traded instruments, or financial contracts.
   (c) Prepared for or by an accounting or consulting firm.
   (d) Prepared for or by an actuarial firm.
4. Specific instances from the list below
   (a) Price
   (b) shadow price
   (c) market price
   (d) model price
   (e) theoretical price
   (f) price curve varying a parameter or other prices
   (g) cash flow
   (h) cash payment
   (i) valuation
   (j) reserve
   (k) capital
   (l) percentile
   (m) conditional tail expectation
   (n) modified conditional tail expectation (as in US American Academy of Actuaries C3 Phase II, i.e. cut off at zero in gain for any scenario)
   (o) required capital
   (p) required reserve
   (q) policy holder behavior
   (r) withdrawal rate
   (s) new business rates
   (t) policy holder elections
   (u) contract behavior variables
   (v) business behavior variables
   (w) corporate behavior variables
Additional specific instances (counter too large for one list)
   (a) market behavior variables
   (b) government behavior variables
   (c) tax rate(s)
   (d) deductions and exclusions
   (e) tax payer utilization of deductions and exclusions
   (f) amount due
   (g) settlement amount
   (h) mortality
   (i) lapse
   (j) prepayment
   (k) exchange rate or rates
   (l) default rate or rates
   (m) reserve against default
   (n) credit migration
   (o) other migration variable (prepay, lapse, expense etc.)
   (p) interest
   (q) accrual
   (r) a value used in computing tax or from a computation of tax whether a tax liability, accrual, cash amount due, penalty, etc.
Mortality, lapse, prepayment, etc. might be as rates or quantities. Multiple groups or types of any of these or other variables are included in this definition.
5. In a legal context, any variable relating to or used in the determination of any of the following:
   (a) Valuation of any amount in a legal framework
   (b) In Contracts, settlement of contracts, damages or restitution
   (c) In Torts.
   (d) Any quantity, numeric or otherwise subject to mathematical analysis or projection that is part of the law of remedies, damages, restitution, etc.
   (e) Real property, mortgages, debt, liens, etc.
   (f) Quantity in a statute
6. Any intermeidate variable or value used or useful to calculate any of the above.
7. Any input variable to any calculation of any of the above variables.
8. Any output variable from any calculation used to calculate or ultimately calculate any of the above variables.

Definition 10.8 (Financial Variable) We shall consider the financial variable and GFV to be the same.

Definition 10.9 (Exponential GFV) An exponential GFV is one where to calculate at least one of the GFV's an exponential function or a numerical algorithm equivalent to such a function call in a standard language is performed.

Definition 10.10 (Short Term Interest Rate Exponential GFV) A short-term interest rate exponential GFV is one where to calculate the short term interest rate, a call to an expnential function is made, or a numerical algorithm equivalent to such a call in a standard language is performed.

Note 10.3 (Algorithm Version) Where an algorithm is not specified for an equation or diagram the following are to be understood as one of the algorithms for that type of calculation. Examples are
1. Discretization
2. Using a “closed form formula” (CFF)
3. Using a CFF as an approximation
4. The corresponding integral/sum form and its corresponding discretization.
5. Taking the corresponding integral/sum form and using approximations to “Green's Functions” or Fundamental Solutions with or without boundary conditions or special side conditions.
6. Using numerical algorithms such as in SIAM journals and publications or other standard references.

The algorithms in turn are to be understood as referring to patentable subject matter, i.e. process or machine or method such as on a digital computer programmed with these algorithms.

Definition 10.11 (Time Loop Initiation Step) Information is reset to the initial values as appropriate. This includes resetting counters, memory, arrays, registers, etc.

Definition 10.12 (Time Loop Recursion Step) Information from the prior time node is updated to the next time node.

Definition 10.13 (Scenario Initiation Step) Information

Definition 10.14 (Next Scenario Step) Information

Definition 10.15 (Scenario Combinations) Information from different scenarios is combined in some applications. For example, a price in some calculations is the average of the discounted cash flows in different scenarios where those discounted cash flows are calculated using the appropriate variables for that scenario, such as cash flows, discount rates, default rates, lapse and pre-payment rates or the like, expenses, taxes, commission, fees, penalties, etc.

Definition 10.16 (Recursive Monte-Carlo) A Monte Carlo that calls a monte carlo. Also called a Monte Carlo within a Monte Carlo. Either or both can use QRMC/LDS or convention random number generation methods. This could be called a simulation within a simulation. Multiple such nested calls are allowed. The word simulation and its synonyms shall allow for this recursive structure in this document.

Definition 10.17 (GFV Simulation) A GFV Simulation Process: A simulation process to simulate a GFV. It can involve input of random variables to calculate the GFV or their probabilities or other measures. This is a set of steps to follow.

Definition 10.18 (GFV-SS: GFV Stochastic Simulator) A GFV Stochastic Simulator (GFV-SS) is defined as:

A GFV Simulation Process based on a stochastic process such as a VAR or RS-VAR.

Definition 10.19 (RS-VAR GFV-SS: RS-VAR GFV Stochastic Simulator) A RS-VAR GFV Stochastic Simulator (GFV-SS) is defined as: a GFV Stochastic simulator that takes output from or uses a RS-VAR. The RS-VAR can be run prior to running another module of the GFV-SS or during it. The RS-VAR can produce a file or data in memory. It can be run before the remaining modules or another module. In a subsequent module, the RS-VAR output can be read from a file or calculated during the other module. Or the other module could use a formula based on the RS-VAR, or calculating a probability or other measure. A characteristic function, Green's function, state price, martingale, or other function can be a module or part of a module. The RS-VAR or other modules can use the so-called P (objective) or Q (risk-neutral) measures or other measures. It can use multiple measures, even inconsistent ones in the same or different modules.

Definition 10.20 (RS-VAR GFV Stochastic Simulator Machine) A computer programmed with an RS-VAR GFV Stochastic Simulator.

Definition 10.21 (RS-VAR GFV Stochastic Simulator Article of Manufacture) A physically tangible item manufactured or altered by the use of a RS-VAR GFV Stochastic Simulator Process or a RS-VAR GFV Stochastic Simulator Machine.

Definition 10.22 (Financial Product)
1. Bond
2. Mortgage
3. CMO
4. Bank account
5. Exchange traded instrument.
6. A financial contract.
7. An ISDA contract.
8. A regulated financial contract.
9. An insurance contract.
10. Annuity.
11. Universal Life.
12. Whole Life.
13. Guarantee.
14. Rider on a policy or contract.
15. etc.

Definition 10.23 (Transaction End-Use (TEU)) An action consisting of one or more of the following actions or the actualization of a result in this list.
1. Preparing data for use in preparing any report listed in the GFV definition.
2. The value of a GFV in a report or file.
3. A transaction involving the purchase or sale of a financial product.
4. A payment related to a financial product.
5. A bid or ask quotation of a financial product.
6. A transaction of a sale, lease, loan, repurchase agreement, formation or sale of a collateralized obligation, etc.
7. A quotation for the same.
8. Preparing one or both of a bid or ask.
9. Transmitting the bid or ask.
10. Accepting a bid or ask.
11. Preparing an indication or appraisal.
12. A transaction subject to an inequality restriction such as a purchase at a lower value than a calculated quantity
13. A transaction subject to a measure, such as a purchase based on a measure of the deviation above a calculated quantity.
14. Valuing inventory of financial instruments or valuing financial contracts.
15. Valuing liabilities or assets.
16. Publication of the values or intermediate values from or associated with the above.
17. Making a purchase, offer, sale, or bid on the internet.
18. Making a purchase, offer, sale, or bid by electronic means.
19. Preparing a report as part of a service of consultation or advisory work.
20. Preparing a report as part of a financial service.
21. Preparing a report as part of a regulated financial service.
22. Advising a purchase, sale, or exercise of an option as part of a financial service.
23. Determing a dividend payment based on a financial report.
24. The paying of a dividend determined in said manner.
25. Determining an amount of a payment based on a financial report.
26. The paying of said amount.
27. Determing a dividend payment based on a financial report that involves quantities reflecting a simulation of future financial condition.
28. Determing a dividend payment based on a financial report that involves quantities reflecting a simulation based on an Essential VAR.
29. The making of said payment.
30. Determing any payment based on a financial report that involves quantities reflecting a simulation based on an Essential VAR.
31. The making of said payment.
32. Determining a credit rating or regulatory condition based on a simulation of an Essential RS-VAR.
33. A purchase or sale of bonds, currency or other securities by a central bank.
34. A purchase or sale of bonds, currency or other securities by a central bank to change a money supply.
35. A purchase or sale of bonds, currency or other securities by a central bank resulting in a change in money supply.
36. Altering an interest rate or credited rate or terms of interest.
37. The preceding done by a central bank.
38. Providing a report or rating to a counter-party or customer or a potential counter-party or customer.
39. Providing a report to a government regulator, exchange or private regulatory body.
40. Preparing such a report.
41. Running a data processing system for the above.
42. Running a “data Processing System for Hub and Spoke Financial Services Configuration” for the above.
43. Attempting any of the above.
44. Preparation for the above.
45. Using an Essential RS-VAR in any of the above.
46. Using a GFV calculated from an Essential RS-VAR in any of the above.
47. Using a stochastic simulator in any of the above.
48. Any of the above using or that used a stochastic simulator.
49. Any of the above using or that used an Essential RS-VAR, or a GFV computed by using an Essential RS-VAR.
50. Any of the above transactions using a computer.
51. Any of the above transactions using data transmission on internet.
52. Executing a transaction such as the above on the internet.
53. Executing a transaction such as the above on a network.

Definition 10.24 (Transaction End Use Quantity (TEUQ)) A transaction end use quantity is any quantity appearing in the transaction end use. This includes any variable from the following list
1. A price appearing in a TEU.
2. A quantity appearing in a TEU.
3. A variable relating to a TEU.
4. A variable relating to a financial product in a TEU.

A computer or the internet can be used to compute a TEU quantity and that TEU quantity encoded onto a physical medium. Such a physical medium might be a computer readable medium or memory.

Elements of the above may be transacted in different places. For example a simulation of future financial condition might be made in one country based on financial contracts in another country and a payment made in a third country. This might be reported in another country. Dividend payments might then be calculated in another country, reported in yet another country and finally paid in another country. Rating agency reports might similarly be prepared somewhere else and reported somewhere else. These might then be used by a counter-party in a derivatives contract, a customer, an advisor, or a financial service firm for advising its customers or managing products or portfolios for them.

Definition 10.25 (End Use Entity (EUE)) An end use entity is an organization or legal entity that uses TEU's, TEUQ's, or the methods, processes, articles of manufacture, machines of this patent. In addition it may be an object that is created, modified, maintained, altered, reported on or used by such an EUE or a counterparty or customer or payment recipient of an EUE.
1. Database
2. Database of Financial Products
3. Database of Financial Product data
4. Database of TEUQ's.
5. Database containing TEUQ's.
6. Database prepared with an Essential RS-VAR.
7. Financial Services Firm.
8. Line of Business.
9. Law firm.
10. Securities class action litigation valuation data.
11. Class a
12. Rating Agency.
13. Ratings report, database or software program accessing it.
14. A portfolio of financial products.
15. A trading desk.
16. A trading desk's positions.
17. A trader's positions.
18. Central Bank.
19. Portfolio.
20. Pension Fund.
21. Pension Portfolio.
22. Money Supply.
23. Portfolio of Debt.
24. Bank.
25. Insurance Company.
26. Derivatives Portfolio.
27. ISDA contract counterparty.
28. Portfolio containing ISDA contracts.
29. Portfolio containing Exchange Traded Contracts.
30. A physical object encoded with any of the above that can be encoded onto a physical object.
31. A machine readable version of said physical object.
32. “Hub and spokes financial services configuration.”

### BIBLIOGRAPHY

[1] Robert F. Dittmar Ahn, Dong-Hyun and A. Ronald Gallant. Quadratic term structure models: Theory and evidence. Review of Financial Studies, 15:243-288, 2002.

[2] Yacine Ait-Sahalia. Testing continuous-time models of the spot rate. The Review of Financial Studies, 9:385-426, 1996.

[3] Yacine Ait-Sahalia. Transition densities for interest rate and other nonlinear diffusions. The Journal of Finance, 54:1361-1395, August 1999.

[4] Kaushik I. Amin and Robert Jarrow. Pricing foreign currency options under stochastic interest rates. Journal of International Money Finance, 10:310-329, 1991.

[5] A. Ang. Short rate nonlinearities and regime switches.

[6] Andrew Ang and Monika Piazzesi. A no-arbitrage vector autoregression of term structure dynamics with macroeconomic and latent variables. Journal of Monetary Economics, 50(4):745-787, 2003.

[7] Ludwig Arnold. Stochastic Differential Equations: Theory and Applications. Krieger, Malabar, Florida, 1972.

[8] Simon H. Babbs and K. Ben Nowman. Kalman filtering of generalized vasicek term structure models. Journal of Financial and Quantitative Analysis, 34(1):115-130, March 1999.

[9] Simon H. Babbs and Nick Webber. Term structure modelling under alternative official regimes. In Mathematics of Derivative Securities, pages 394-422. Cambridge University Press, 1997.

[10] Louis Bachelier. Theorie de la speculation (thesis). Annales Scientifiques de l'Ecole Normale Superieure, I I I-17:21-86, 1900.

[11] Pierluigi Balduzzi, Sanjiv Rajan Das, Silverio Foresi, and Rangarajan Sundaram. A simple approach to three-factor term structure models. The Journal of Fixed Income, 6:43-53, December 1996.

[12] Pierluigi Balduzzi, Sanjiv Rajan Das, Silverio Foresi, and Rangarajan Sundaram. Stochastic Mean Models of the Term Structure of Interest Rates, chapter 5, pages 10-119. Wiley, N.Y., 2000.

[13] Ravi Bansal, George Tauchen, and Hao Zhou. Regime-shifts, risk premiums in the term structure, and the business cycle. Technical Report 2003-21, Board of Governors of the Federal Reserve System, Washington, April 2003.

[14] Ravi Bansal and Hao Zhou. Term structure of interest rates with regime shifts. Journal of Finance, 57:1997-2043, 2002.

[15] Ravi Bansal and Hao Zhou. Ito conditional moment generator and the estimation of short rate processes. Journal of Financial Econometrics, 1:250-271, 2003.

[16] Rolf Banz and Merton Miller. Prices for state contingent claims: Some estimates and applications. Journal of Business, pages 653-672, October 1978.

[17] David Beaglehole and Mark Tenney. Multicurrency pricing. Working paper, University of Chicago, 1990.

[18] David Beaglehole and Mark Tenney. Stochastic volatility. Working paper, University of Chicago, 1990.

[19] David Beaglehole and Mark Tenney. General solutions to some interest rate contingent claims pricing equations. Journal of Fixed Income, September 1991.

[20] David Beaglehole and Mark Tenney. Corrections and additions to, “a nonlinear equilibrium model of the term structure of interest rates”. Journal of Financial Economics, 32(3):345-354, December 1992.

[21] Albert Turner Bharucha-Reid. Elements of the Theory of Markov Processes and Their Applications. McGraw-Hill, New York, N.Y., 1960.

[22] Fischer Black and Myron Scholes. The pricing of options and corporate liabilities. Journal of Political Economy, (8):637-654, 1973.

[23] Justin Bobo, Lee Tenney, and Mark S. Tenney. Stochastic asset generators for investment portfolios of bonds, stocks, real estate, commodities, and foreign assets based on the double mean reverting process and the vector autoregressive diffusion. Technical report, Mathematical Finance Company, Alexandria, Va., 1999.

[24] Tim Bollerslev and Hao Zhou. Volatility puzzles: A unified framework for gauging return-volatility regressions. Technical Report 2003-40, Board of Governors of the Federal Reserve System, Washington, August 2003.

[25] A. James Boness. Elements of a theory of stock-option value. Journal of Political Economy, 72(2):163-175, 1964.

[26] Phelim Boyle and Ken Seng Tan. Applications of randomized low discrepancy sequences to the valuation of complex securities. Journal of Economic Dynamics and Control, 24(11-12):1747-82, 2000.

[27] Phelim P Boyle. Options: A monte carlo approach. Journal of Financial Economics, 4:323-38, 1977.

[28] Phelim P Boyle, Mark Broadie, and Paul Glasserman. Monte-carlo methods for security pricing. Journal of Economic Dynamics and Control, 21:1267-1321, 1997.

[29] Douglas T. Breeden and Robert H. Litzenberger. Prices of state-contingent claims implicit in option prices. Journal of Business, 51:621-651, 1978.

[30] George Chacko and Sanjiv Rajan Das. Pricing interest rate derivatives: A general approach. The Review of Financial Studies, 15:195-241, 2002.

[31] Don Chance. Bibliography of term structure and interest rate derivatives literature. Technical report, Lousiana State University, 2004.

[32] Lin Chen. A Three Factor Model of the Term Structure of Interest Rates. PhD dissertation, Harvard University, Department of Economics, January 1995.

[33] Lin Chen. Interest Rate Dynamics, Derivatives Pricing, and Risk Management. Springer-Verlag, Berlin Heidelberg, 1996.

[34] Ren-Raw Chen and Louis Scott. Pricing interest rate options in a two factor cox-ingersoll-ross model of the term structure. Review of Financial Studies, 5:613-636, 1992.

[35] George Constantinides. A theory of the nominal term structure of interest rates. Review of Financial Studies, 5(4):531-552, 1992.

[36] John Cox, Jonathon Ingersoll, and Stephen A. Ross. The relation between forward prices and futures prices. Journal of Financial Economics, (9):321-346, December 1981.

[37] John Cox, Jonathon Ingersoll, and Stephen A. Ross. An intertemporal general equilibrium model of asset prices. Econometrica, 53(2):363-384, March 1985.

[38] John Cox, Jonathon Ingersoll, and Stephen A. Ross. A theory of the term structure of interest rates. Econometrica, 53(2):385-407, 1985.

[39] John Cox and Stephen A. Ross. The valuation of options for alternative stochastic processes. Journal of Financial Economics, 3:145-66, 1976.

[40] Steven Craighead and Mark S. Tenney. Economic scenario generator for insurance and pension rational decision making under uncertainty. Technical report, Society of Actuaries, September 1997.

[41] Qiang Dai and Kenneth Singleton. Fixed income pricing. In George Constantinides, Michael Harris, and Rene Stulz, editors, Handbook of Economics and Finance. North Holland, San Diego, Calif. 92101, 2003.

[42] Qiang Dai and Kenneth Singleton. Term structure dynamics in theory and reality. The Review of Financial Studies, 16(3):631-678, Fall 2003.

[43] Sanjiv Ranjan Das. Interest Rate Shocks, Characterizations of the Term Structure and the Pricing of Interest Rate Sensitive Contingent Claims. PhD dissertation, New York University, Stern School of Business, July 1994.

[44] Micheal Davlin and Mark Tenney. Pricing with stochastic exchange and interest rates. Unpublished paper, 1997-2003.

[45] Darrell Duffie. Dynamic Asset Pricing Theory. Princeton University Press, Princeton, third edition, 2001.

[46] Darrell Duffie and Rui Kan. A yield factor model of interest rates. Mathematical Finance, 6:379-406, 1996.

[47] Darrell Duffie, Jun Pan, and Kenneth Singleton. Transform analysis and asset pricing for affine jump diffusions. Econometrica, 68:1343-1376, 2000.

[48] Darrell Duffie and Kenneth Singleton. Credit Risk: Pricing, Measurement and Management. Princeton University Press, Princeton, 2003.

[49] Darrell Duffie and Domingo Tavella, editors. First Annual Computational Finance Conference at Stanford, New York and Palo Alto, Calif., August 1996. International Association of Financial Engineers and Stanford University.

[50] Paul Embrechts, Filip Lindskog, and Alexander McNeil. Correlation and dependence in risk management: properties and pitfalls. In M.A.H. Dempster, editor, Risk Management: Value at Risk and Beyond. Cambridge University Press, Cambridge University Press, 2002.

[51] Adrian Luis Eterovic. Essays on multifactor models of the term structure of interest rates. PhD dissertation, Harvard University, Department of Economics, May 1994.

[52] a Peter Fitton. A Green's Function Finite Difference Method and Applications to Security Valuation. Master's thesis, University of Waterloo, May 1995.

[53] Mark Garman. A general theory of asset valuation under diffusion state processes. Technical report, Berkeley, 1976.

[54] Mark Garman and Steven Kohlhagen. Foreign currency option values. Journal of International Money and Finance, 2(3):231-237, December 1983.

[55] Donald P. Groover. Cope^{R}: A trading quality system. Chalke: PTS Newsletter, June 1992.

[56] Donald P. Groover and Mark S. Tenney. Comparison of cope^{R} and the lognormal model: Out of sample pricing of treasury bonds. Chalke: PTS Newsletter, April 1992.

[57] Donald P. Groover and Mark S. Tenney. Cope^{R}: Application in project finance. Chalke: PTS Newsletter, September 1992.

[58] Nils Hakansson. Optimal Investment and Consumption Strategies for a class of Utility Functions. PhD dissertation, UCLA, Department of Economics, June 1966.

[59] Nils H. Hakansson. Optimal investment and consumption strategies under risk for a class of utility functions. Econometrica, 38(5):587-607, September 1970.

[60] James D. Hamilton. Rational expectations econometric analysis of changes in regime: An investigation of the term structure of interest rates. Journal of Economic Dynamics and Control, 13:385-423, June/September 1988.

[61] James D. Hamilton. A new approach to the economic analysis of non-stationary time series and the business cycle. Econometrica, 57(2):357-84, 1989.

[62] James D. Hamilton. Time Series Analysis. Princeton University Press, Princeton, 1994.

[63] James D. Hamilton and Baldev Raj. Advances in Markov-Switching Models Applications in Business Cycle Research and Finance. Studies in Empirical Economics. Springer, Heidelberg and Berlin, 2002.

[64] Geoffrey Hancock. Bringing risk into capital management: Capital measures for variable annuities with guarantees, session 240f. In Spring 2003 Meeting Washington. Society of Actuaries, May 2003.

[65] Mary Hardy. A regime switching model of long term stock returns. North American Actuarial Journal, 5(2):41-53, April 2001.

[66] Mary Hardy. Investment Guarantees: The New Science of Modeling and Risk Management for Equity-Linked Life Insurance. John Wiley & Sons, Hoboken, N.J., 2003.

[67] J. M. Harrison and David Kreps. Martingales and arbitrage in multi-period securities markets. Journal of Economic Theory, 20:381-408, July 1979.

[68] J. M. Harrison and S. Pliska. Martingales and stochastic integrals in the theory of continuous trading. stochastic processes and their applications, 11:215-60, 1981.

[69] J. M. Harrison and S. Pliska. A stochastic calculus model of continuous trading: complete markets. stochastic processes and their applications, 15:313-16, 1983.

[70] David Heath, Robert Jarrow, and Andrew Morton. Bond pricing and the term structure of interest rates: A new methodology for contingent claim valuation. Econometrica, 60(1):77-105, 1992.

[71] Steven L. Heston. A closed-form solution for options with stochastic volatility with applications to bond and currency options. Review of Financial Studies, 6(2):327-343, 1993.

[72] Thomas Ho and S. Lee. Term structure movements and pricing interest rate contingent claims. Journal of Finance, 41:1011-29, 1986.

[73] Marjorie Hogan and Michael Hogan. Private communication, 1987.

[74] John Hull and Alan White. Pricing interest rate derivative securities. Review of Financial Studies, 3(4):573-592, 1990.

[75] Jonathan Ingersoll. Theory of Financial Decision Making. Rowman and Littlefield, Totowa, N.J., 1987.

[76] Jonathan E. Jr. Ingersoll. Contingent foreign exchange contracts. Technical report, Yale, 1989.

[77] Farshid Jamshidian. Pricing of contingent claims in the one factor term structure model. Technical report, Merrill Lynch, 1987.

[78] Farshid Jamshidian. Pricing of contingent claims in the one factor term structure model. Technical report, Merrill Lynch, 1987.

[79] Farshid Jamshidian. An exact bond option formula. Journal of Finance, 44:205-209, 1989.

[80] Farshid Jamshidian. The multifactor gaussian interest rate model and implementation. Technical report, Merrill Lynch, 1989.

[81] Farshid Jamshidian. Bond, futures, and option evaluation in the quadratic interest rate model. Technical report, Fuji International Finance PLC, 7-11 Finsbury Circus, London EC2M 7NT, March 1993.

[82] Farshid Jamshidian. Hedging quantos, diff swaps, and ratios. Technical report, Fuji International Finance PLC, 7-11 Finsbury Circus, London EC2M 7NT, 1993.

[83] Farshid Jamshidian. A simple class of square-root interest rate models. Technical report, Fuji International Finance PLC, 7-11 Finsbury Circus, London EC2M 7NT, March 1993.

[84] Hans-Jurgen Knoch. The pricing of foreign currency options with stochastic volatility. Working Paper, April 1990.

[85] Paul Krugman. Target zones and exchange rate dynamics. Working Paper, (2481), 1988.

[86] Richard Kruizenga. PUT AND CALL OPTIONS: A THEORETICAL AND MARKET ANALYSIS. PhD dissertation, MIT, Department of Economics, 1956.

[87] Clarence Langetieg. A multivariate model of the term structure. Journal of Finance, 35(1):71-97, March 1980.

[88] Dominique Lebel, Geoffrey Hancock, and Jeffrey Leitz. Risk based capital guarantees on variable annuities with guarantees session 91 of orlando annual meeting. Record, 29(3), October 2003.

[89] Markus Leippold and Lauren Wu. Asset pricing under the quadratic class. Journal of Financial and Quantitative Analysis, 37(2):271-295, 2002.

[90] Francis A. Longstaff. A nonlinear general equilibrium model of the term structure of interest rates. Journal of Financial Economics, 23:195-224, 1989.

[91] Francis A. Longstaff. The valuation of options on yields. Journal of Financial Economics, 26:97-121, 1990.

[92] Francis A. Longstaff and Eduardo S. Schwartz. Interest rate volatility and the term structure: A two-factor general equilibrium model. Journal of Finance, 47:1259-1282, 1992.

[93] Robert E. Lucas. Asset prices in an exchange economy. Econometrica, 46(6):1426-1446, 1978.

[94] John Manistre. A geometric approach to exact solutions in finance and actuarial science. Technical report, Society of Actuaries, August 1997.

[95] Henry P. McKean. Appendix: A free boundary problem for the heat equation arising from a problem in mathematical economics. Industrial Management Review, 32(9), Spring 1965.

96] Robert C. Merton. A dynamic general equilibrium model of the asset market and its application to the pricing of the capital structure of the firm. Technical report, A. P. Sloan School of Management, Massachusetts Institute of Technology, Cambridge, Massachusetts, 1970.

[97] Robert C. Merton. An intertemporal capital asset pricing model. Econometrica, 41:867-887, September 1973.

[98] Robert C. Merton. The theory of rational option pricing. Bell Journal of Economics and Management Science, 4:141-183, 1973.

[99] Robert C. Merton. Continuous-Time Finance. Basil Blackwell, Cambridge, Mass. 02142, 1990.

[100] Roger B. Nelsen. An Introduction to Copulas. Springer-Verlag, N.Y., 1998.

[101] Harald Niederreiter. Random Number Generation and Quasi-Monte Carlo Methods. Society of Industrial and Applied Mathematics, Philadelphia, 1992.

[102] Committee on Life Insurance Financial Reporting. Selection of interest rate models. Technical Report 203106, Canadian Institute of Actuaries, December 2003.

[103] CIA Task Force on Segregated Funds Investment Guarantees. Final report. Technical Report 202012, Canadian Institute of Actuaries, March 2002.

[104] Jun Pan. Jump-Diffusion Models of Asset Prices: Theory and Empirical Evidence. PhD dissertation, Stanford University, Graduate School of Business, May 2000.

[105] Joseph F. Paskov and Anargyros Papageorgiou. New results on deterministic pricing of financial derivatives. Technical report, CUCS-028-96 Computer Science, Columbia University, 1996.

[106] Rajni V. Patel, Alan J Laub, and Paul M. Van Dooren. Numerical Linear Algebra Techniques for Systems and Control. IEEE Press, 445 Hoes Lane, PX Box 1331, Piscataway, N.J. 08855-1332, 1993.

[107] Monika Piazzesi. Essays on Monetary Policy and Asset Pricing. PhD dissertation, Stanford University, Department of Economics, 2003.

[108] Scott Richard. An arbitrage model of the term structure of interest rates. Journal of Financial Economics, (6):33-57, 1978.

[109] Paul A. Samuelson. Rational theory of warrant pricing. Industrial Management Review, 32(9), Spring 1965.

[110] Albert Nikolaevich Shiryaev. Probability. Springer, Heidelberg, Berlin, second edition, 1996.

[111] Albert Nikolaevich Shiryaev. Essentials of Stochastic Finance: Facts, Models, Theory. World Scientific, Singapore, 1999.

[112] Case Sprenkle. Warrant Prices as Indicators of Expectations and Preferences. PhD dissertation, Yale University, Department of Economics, 1960.

[113] Life Capital Adequacy Subcommittee. Recommended approach for setting regulatory risk-based capital requirements for variable products with guarantees (excluding index guarantees). Technical report, American Academy of Actuaries, December 2002.

[114] Life Capital Adequacy Subcommittee. Progress report: C3 phase ii. Technical report, American Academy of Actuaries, June 2003.

[115] Life Capital Adequacy Subcommittee. Recommended approach for setting regulatory risk-based capital requirements for variable products with guarantees (excluding index guarantees). Technical report, American Academy of Actuaries, December 2003.

[116] Risk Management Task Force: Equity Modelling Subgroup. Modelling and managing equity risk: Recommended reading list. Technical report, Society of Actuaries, May 15 2003.

[117] Mark S. Tenney. Stochastic interest rate parity. Working Paper, University of Chicago, 1989.

[118] Mark S. Tenney. The double mean reverting process™. Technical report, 4313 Lawrence Street, Alexandria, Va. 22309, 1995.

[119] Mark S. Tenney. The green's function numerical method™. Technical report, Society of Actuaries, 4313 Lawrence Street, Alexandria, Va. 22309, 1995.

[120] Mark S. Tenney. The green's function numerical method™. In Darrell Duffie and Domingo Tavella, editors, First Annual Computational Finance Conference at Stanford, New York and Palo Alto, Calif., August 1996. International Association of Financial Engineers and Stanford University.

[121] Mark S. Tenney. Discrepancy and discrepancies in monte carlo. Technical report, Mathematical Finance Company, 4313 Lawrence Street, Alexandria, Va. 22309, June 2003.

[122] Stuart M. Turnbull and Angelo Melino. Pricing foreign currency options with stochastic volatility. Journal of Econometrics, 3:239-265, 1990.

[123] Stuart M. Turnbull and Angelo Melino. The pricing of foreign currency options. Canadian Journal of Economics, 3:251-281, May 1991.

[124] Stuart M. Turnbull and Frank Milne. A simple approach to interestrate option pricing. Review of Financial Studies, 4(1):87-120, 1991.

[125] Oldrich Vasicek. An equilibrium characterizatin of the term structure. Journal of Financial Economics, (5):177-188, 1977.

[126] Gary Venter. Quantifying correlation with copulas. Guy Carpenter, 2003.

[127] Hao Zhou. Jump-diffusion term structure and ito conditional moment generator. Technical Report 2001-28, Board of Governors of the Federal Reserve System, Washington, April 2001.

### CHAPTER 11

11.1 Claims Essential VAR-RS

1. (Simulating GFV with Essential RS-VAR.) The method of simulating GFV variables using an essential RS-VAR.

2. (Interest rates and equities both have regime switching) The method of claim one wherein there are at least two regimes and at least one parameter relating to a variable in the RS-VAR used to calculate a rate and one parameter relating to a variable in the RS-VAR used to calculate an equity variable have values that are different in at least two regimes.

3. (Interest rates and equities both have regime switching) The method of the foregoing claim wherein at least one of the rates is an interest rate.

4. (Simulating GFV with Essential RS-VAR with TEU.) The method of claim one of simulating a GFV and the execution of a Transaction End Use using said GFV.

5. (Simulating GFV with Essential RS-VAR with TEU.) The method of claim one of simulating a GFV and the execution of a Transaction End Use using said GFV as a TEUQ.

6. (Simulating GFV with Essential RS-VAR.) The method of claim one wherein a rate calculation involves a call to the exponential function.

7. (Simulating GFV with Essential RS-VAR.) The method of claim one wherein the short term default free rate of interest is the exponential of a variable in the VAR in an accessible region of the state space.

8. (A computer encoded with a RS-VAR GFV) A computer encoded with a software program to compute a GFV by means of an essential RS-VAR.

9. (Use of said computer and end-use) The computer of the foregoing claim used to determine a quantity in a “transaction end use” and the execution, of that “transaction end-use”.

10. (Article of Manufacture) A physical object created by the use of the method of claim one.

11. (Article of Manufacture) The physical object of the foregoing claim where the object contains in computer readable form a Transaction End Use Quantity.

12. (EUE) An EUE wherein the TEU's creating, reporting or modifying said portfolio have a quantity determined using one of a plurality consisting of the method of claim one or a machine of claim 8 or an article of manufacture of claim 10.

13. (A portfolio) The EUE of the preceding claim wherein the EUE is a portfolio.

14. (A portfolio) The portfolio of the foregoing claim wherein a TEU creating, reporting or modifying said portfolio have a quantity determined using the method of claim one as further modified by the additional limitation that there are at least two regimes and at least one parameter relating to a variable in the RS-VAR used to calculate a rate and one parameter relating to a variable in the RS-VAR used to calculate an equity variable have values that are different in at least two regimes.

15. (A line of business) An EUE of claim 12 where the EUE is a line of business of a financial services firm.

16. (A line of business) The line of business of the preceding claim wherein the method of claim one is further restricted by the additional limitation that there are at least two regimes and at least one parameter relating to a variable in the R S-VAR used to calculate a rate and one parameter relating to a variable in the RS-VAR used to calculate a n equity variable have values that are different in at least two regimes.
